(19) United States
(12) Patent Application Publication
(10) Pub. No.: US 2019/0378064 A1
(43) Pub. Date: Dec. 12, 2019

(54) CONSOLIDATED MANAGEMENT CONTROL APPARATUS, CONSOLIDATED MANAGEMENT CONTROL ASSISTANCE SYSTEM, CONSOLIDATED MANAGEMENT CONTROL ASSISTANCE METHOD, AND NON-TRANSITORY COMPUTER-READABLE RECORDING MEDIUM

(71) Applicant: Mitsubishi Electric Corporation, Chiyoda-ku, Tokyo (JP)

(72) Inventor: Yujiro KAWASAKI, Tokyo (JP)

(73) Assignee: Mitsubishi Electric Corporation, Chiyoda-ku, Tokyo (JP)

(21) Appl. No.: 16/485,308

(22) PCT Filed: Nov. 2, 2017
(86) PCT No.: PCT/JP2017/039810

§ 371 Date: Aug. 12, 2019

(30) Foreign Application Priority Data
Feb. 20, 2017 (JP) 2017-029117

(51) Int. Cl. G06Q 10/06; G06Q 30/02

(52) U.S. Cl. CPC G06Q 10/0631; G06Q 30/0206; G06Q 10/0637

(57) ABSTRACT

A consolidated management control apparatus includes a business-related information acquirer, a storage, an inputter, a consolidated management control information generator, and an outputter. The business-related information acquirer acquires sales business-related information including, product-by-product, actual results information and plan information for each sales base within a business group, and production business-related information including, product-by-product, actual results information and plan information for each production base, and the storage stores the acquired information. The inputter receives designation of at least one of the sales bases and at least one of the production bases, and receives designation of at least one of products handled by both of designated bases. The consolidated management control information generator generates, based on the information stored in the storage, consolidated management control information including indicator data indicating consolidated financial status of both the bases for each designated product, and the outputter outputs the consolidated management control information.

### TECHNICAL FIELD

The present disclosure relates to a consolidated management control apparatus, a consolidated management control assistance system, a consolidated management control assistance method, and a program.

### BACKGROUND ART

With increased diversification and globalization of business activity, management control is increasingly important for a business group that includes a parent company as well as subsidiary companies, affiliated companies, or the like. With such increased diversification and globalization, technology is desired for supporting determination of business policy of the entire business group. For example, Patent Literature 1 mentions a decision-making support system that supports decision-making of a user by evaluating a business performance and providing qualitatively causes resulting in such a business performance.

### CITATION LIST

### Patent Literature

Patent Literature 1: Unexamined Japanese Patent Application Kokai Publication No. 2006-301834

### SUMMARY OF INVENTION

### Technical Problem

The decision-making support system mentioned in Patent Literature 1 counts product-by-product shipment actual results of products sold wholesale by a single production base to each sales base and product-by-product sales actual results and inventory status of each sales base. The decision-making support system, based on the counts, calculates product-by-product sales amounts and profit ratios of the production base and each sales base, calculates values for each element indicating an internal factor resulting in such a business performance, and provides the calculated values to a user.

In this manner, the decision-making support system mentioned in Patent Literature 1 stops at analysis of mutual financial status between the single production base and each of the sales bases purchasing and selling the products manufactured and shipped by this production base, and this decision-making support system is unable to perform mutual financial analysis between each of multiple production bases and each of the sales bases purchasing and selling the products manufactured and shipped by such production bases. Thus the decision-making support system mentioned in Patent Literature 1 has difficulty in effectively supporting determination of business policy of a business group that has a large variety of internal trading relationships among production bases and sales bases.

In consideration of the aforementioned circumstances, an objective of the present disclosure is to effectively support the determination of business policy of the business group.

### Solution to Problem

In order to attain the aforementioned objective, the consolidated management control apparatus according to the present disclosure is equipped with an acquirer, a storage, an inputter, a generator, and an outputter. The acquirer acquires (i) sales business-related information that includes, product-by-product, actual results information and plan information for each of sales bases within a business group, and (ii) production business-related information that includes, product-by-product, actual results information and plan information for each of production bases within the business group. The storage stores the sales business-related information and the production business-related information acquired by the acquirer. The inputter receives designation of at least one of the sales bases and designation of at least one of the production bases, and receives designation of at least one of products handled by both of the designated sales base and the designated production base. The generator generates, based on the sales business-related information and the production business-related information stored by the storage, consolidated management control information for each product designated by the inputter. The consolidated management control information includes indicator data that indicates financial status of the designated sales base calculated using a sales quantity of the designated sales base, and indicator data that indicates financial status of the designated production base calculated by replacing a shipment quantity of the designated production base with the sales quantity of the designated sales base. The outputter outputs the consolidated management control information generated by the generator.

### Advantageous Effects of Invention

According to the present disclosure, the consolidated management control apparatus integrally manages, product-by-product, the information relating to the sales business of the sales bases within the business group and the information relating to the production business of the production bases within the business group, and generates and outputs consolidated management control information indicating the consolidated financial status of the sales bases and the production bases. Thus the consolidated management control apparatus can effectively support the determination of business policy of the business group.

### BRIEF DESCRIPTION OF DRAWINGS

FIG. 1 illustrates configuration of a consolidated management control assistance system according to an embodiment of the present disclosure;

FIG. 2 is a block diagram illustrating configuration of a sales business control device;

FIG. 3A illustrates an example of a sales base PSI actual results table;

FIG. 3B illustrates an example of a sales base PSI plan table;

FIG. 4 is a block diagram illustrating configuration of a production business control device;

FIG. 5A illustrates an example of a production base PSI actual results table;

FIG. 5B illustrates an example of a production base PSI plan table;

FIG. 6 is a block diagram illustrating configuration of a consolidated management control apparatus;

FIG. 7A illustrates an example of a product-by-product sales base PSI actual results table;

FIG. 7B illustrates an example of a product-by-product sales base PSI plan table;

FIG. 8A illustrates an example of a product-by-product production base PSI actual results table;

FIG. 8B illustrates an example of a product-by-product production base PSI plan table;

FIG. 9A illustrates an example of a sales base business information table;

FIG. 9B illustrates an example of a production base business information table;

FIG. 9C illustrates an example of a related-business information table;

FIG. 9D illustrates an example of a consolidated business information table; and

FIG. 10 is a flowchart illustrating consolidated management control information generation processing.

### DESCRIPTION OF EMBODIMENTS

A consolidated management control system according to an embodiment of the present disclosure is described below with reference to drawings.

A consolidated management control assistance system 1 according to the embodiment of the present disclosure is a system that supports determination of business policy of a business group by generating and providing consolidated management control information. Here, “consolidated management control information” is information, generated on the basis of business-related information relating to business of each of a plurality of sales bases within the business group and business of each of a plurality of production bases within the business group, including indicator data indicating consolidated financial status of both the sales bases and the production bases. Moreover, the determination of the business policy of the business group includes various types of decision-making of importance business-wise for the business group such as devising of a business strategy, setting of a business target, or the like.

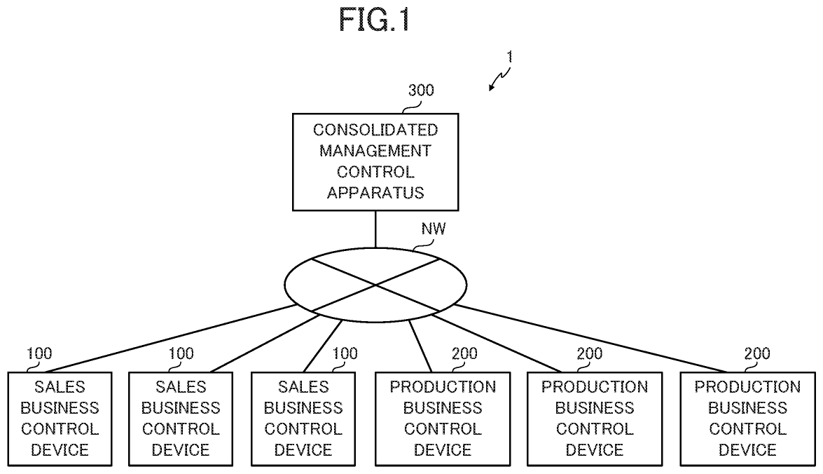

As illustrated in FIG. 1, the consolidated management control assistance system 1 is equipped with sales business control devices 100 for management of a sales business of the sales bases, production business control devices 200 for management of a production business of the production bases, and a consolidated management control apparatus 300 for management of a consolidated financial status of the business group. The consolidated management control apparatus 300 is mutually communicatively connected with the sales business control device 100 and the production business control device 200 via a network NW constructed by suitable combination of wireless and wired communication circuits. Although three each of sales business control devices 100 and production business control devices 200 are illustrated in FIG. 1, a freely selected number of the sales business control devices 100 and the production business control devices 200 can be used in the present embodiment in accordance with the numbers of the sales bases and production bases possessed by the business group. Moreover, hereinafter the term “sales business control device 100” sometimes may collectively indicate multiple sales business control devices or may indicate a single sales business control device included in the consolidated management control assistance system 1. In the same manner, the term “production business control device 200” sometimes may collectively indicate multiple production business control devices or may indicate a single production business control device included in the consolidated management control assistance system 1.

The sales business control device 100 is installed at each of the sales bases, and creates sales business-related information 121 including various types of information relating to the sales business occurring at the sales base and provides the created information to the consolidated management control apparatus 300. Specific content of the sales business-related information 121 is described later.

The production business control device 200 is installed at each of the production bases, and creates the production business-related information 221 including various types of information relating to the production business occurring at the production base where the production business control device 200 is installed, and provides the created information to the consolidated management control apparatus 300. Specific content of the production business-related information 221 is described later.

The consolidated management control apparatus 300 is installed in a managing business department that acts as a central administration of business of the business group, and on the basis of the sales business-related information 121 acquired from the sales business control devices 100 and the production business-related information 221 acquired from the production business control devices 200, generates consolidated management control information and provides the generated information to a user. The user of the consolidated management control apparatus 300 is typically a responsible person in charge of tasks such as determining business policy, devising business strategy, or the like, of the business group. Specific content of the consolidated management control information is described later.

Next, configurations of each of the sales business control device 100, the production business control device 200, and the consolidated management control apparatus 300 included in the consolidated management control assistance system 1 is described.

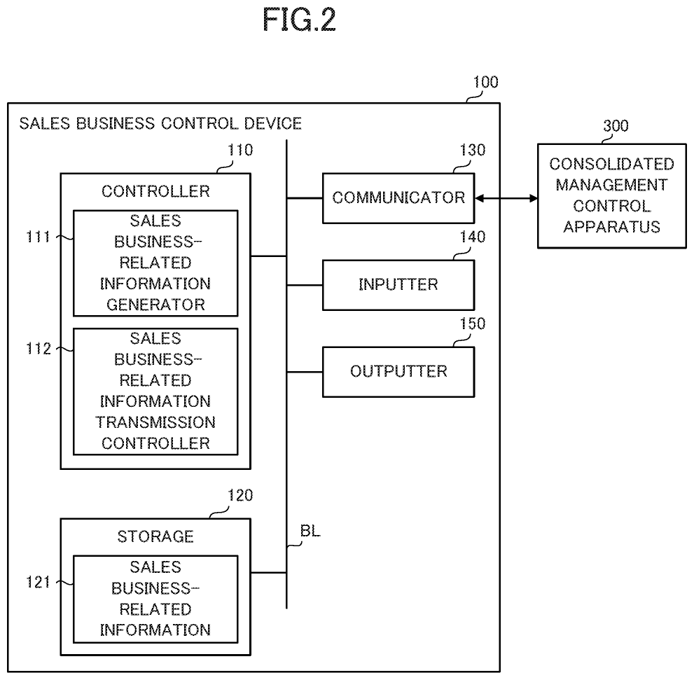

As illustrated in FIG. 2, the sales business control device 100 is equipped with a controller 110, a storage 120, a communicator 130, an inputter 140, and an outputter 150. These components are electrically connected together via a bus line BL.

The controller 110 includes a computer that has a central processing unit (CPU), a random access memory (RAM), a read only memory (ROM), or the like. The controller 110 controls each of the components of the sales business control device 100 by reading various types of operating programs stored in the ROM and executing the programs on the RAM.

The controller 110 functionally has a sales business-related information generator 111 and a sales business-related information transmission controller 112.

The sales business-related information generator 111 generates the sales business-related information 121 that includes various types of data relating to the sales business occurring at the sales bases. Moreover, the sales business-related information generator 111 stores the generated sales business-related information 121 in the storage 120 described later.

The sales business-related information transmission controller 112 controls the communicator 130 to transmit to the consolidated management control apparatus 300 the sales business-related information 121 stored in the storage 120.

Furthermore, the sales business-related information generator 111 and the sales business-related information transmission controller 112 may be included in a single computer, or each may be included in a separate computer.

Here, specific content of the sales business-related information 121 is described. The sales business-related information 121 includes (i) sales base PSI actual results information indicating procurement, sales, and inventory (PSI) actual results of the sales base and (ii) sales base PSI plan information indicating a PSI plan of the sales base.

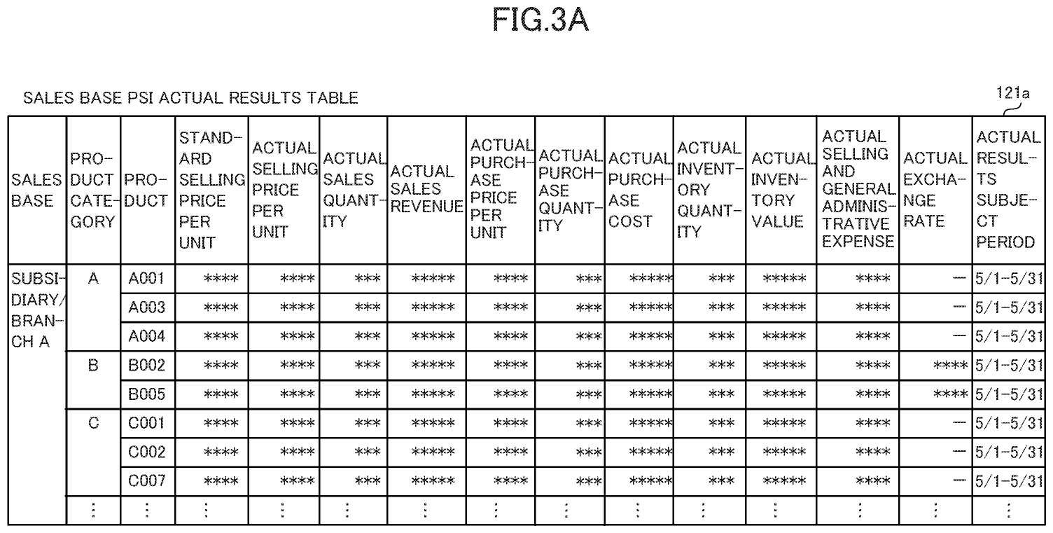

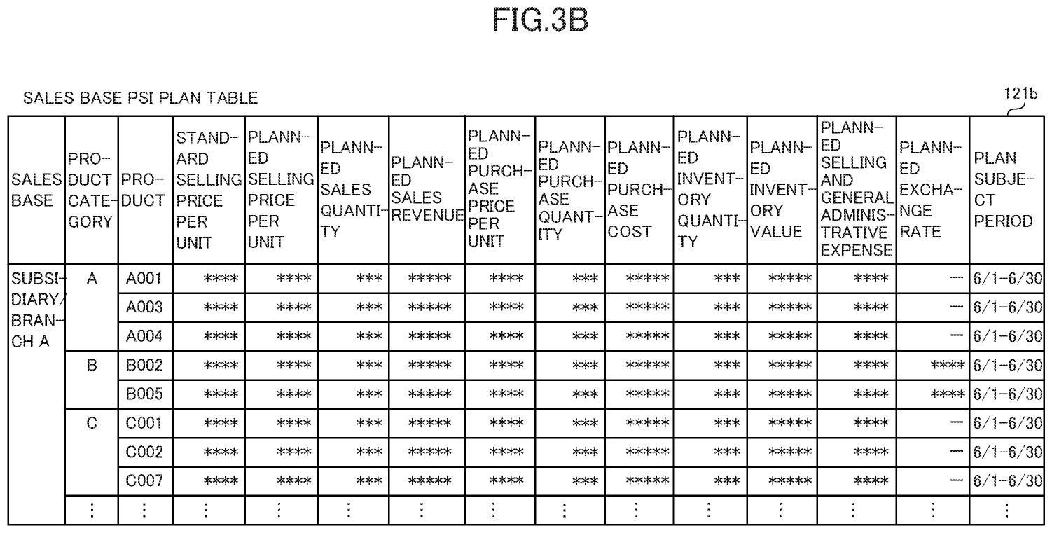

Specifically, the sales base PSI actual results information includes various items of data of a sales base PSI actual results table 121a illustrated in FIG. 3A. The sales base PSI actual results table 121a includes, in association with one another, the various items of data that are a “sales base”, a “product category”, a “product”, a “standard selling price per unit”, an “actual selling price per unit”, an “actual sales quantity”, an “actual sales revenue”, an “actual purchase price per unit”, an “actual purchase quantity”, an “actual purchase cost”, an “actual inventory quantity”, an “actual inventory value”, an “actual selling and general administrative expense”, an “actual exchange rate”, and an “actual results subject period”.

The “actual results subject period” is an item indicating a period subject to calculation of the various numeric data. In the sales base PSI actual results table 121a illustrated in FIG. 3A, the actual results subject period is set to be a one month period of from May 1st to May 31st. In this manner, in the present embodiment, the actual results subject period is one month long, and the sales business control device 100 is described as creating the sales base PSI actual results table 121a in one month units and transmitting, as monthly sales base PSI actual results information, the sales base PSI actual results table 121a to the consolidated management control apparatus 300 together with a sales base PSI plan table 121b described later. Furthermore, the sales business control device 100 may create the sales base PSI actual results table 121a, with the actual results subject period being set to a period longer or shorter than one month, such as three months or one week, and transmit the sales base PSI actual results table 121a to the consolidated management control apparatus 300.

The “sales base” is an item indicating identification information for identifying the sales base within the business group. For example, a sales base ID previously assigned to each sales base, or a formal name, a popular name, or the like of each sales base is used for this identification information. The “product category” is an item indicating classes of products. For example, a product category ID previously assigned to each product category is used for this product category. The “product” is an item indicating identification information for identifying each product. For example, a product ID previously assigned to each product is used for the product. The sales base PSI actual results table 121a illustrated in FIG. 3A stores items of data for each of the products, such as products “A001”, “A003”, and “A004” of a product category “A” sold by a sales base “subsidiary/branch A” to customers in the actual results subject period, products “B002” and “B005” of the product category “B”, or the like.

The “standard selling price per unit” is an item indicating a selling price per single product serving as a standard reference when the sales base sells the product to a business connection. The “actual selling price per unit” is an item indicating a selling price per single product actually sold by the sales base to the customer in the actual results subject period. For example, in the case of occurrence of multiple sales transactions in the actual results subject period, the “actual selling price per unit” is obtained by calculating an average value of the selling prices per unit discounted from the standard selling price per unit while taking into account past purchasing actual results, the present purchase quantity, or the like, of the business connection for each transaction. The “actual sales quantity” is an item indicating a total quantity of the product sold by the sales base to the customer in the actual results subject period. The “actual sales revenue” is an item indicating a sum of the sales monetary amounts of the products sold by the sales base in the actual results subject period. This actual sales revenue is calculated by multiplying together the actual selling price per unit and the actual sales quantity.

The “actual purchase price per unit” is an item indicating a purchase price per unit of the product purchased by the sales base from the production base within the business group in the actual results subject period. The “actual purchase quantity” is an item indicating a total quantity of the product purchased by the sales base from the production base in the actual results subject period. The “actual purchase cost” is an item indicating a sum of the purchase monetary amounts of the product purchased by the sales base from the production base in the actual results subject period. This actual purchase cost is calculated by multiplying together the actual purchase price per unit and the actual purchase quantity. Furthermore, in the case in which the product purchased by the sales base is imported from an overseas production base, import charges that are various overhead expenses including custom duties, customs clearance fees, insurance amount, shipping, and the like are taken to be added to the actual purchase cost and a planned purchase cost.

The “actual inventory quantity” is an item indicating the quantity of the product held as inventory by the sales base on an end date of the actual results subject period. The “actual inventory value” is an item indicating an appraised value of the product held as inventory by the sales base on the end date of the actual results subject period. For example, the “actual inventory value” is calculated using the formula: “Initial inventory value+Actual purchase cost−Actual sales revenue”. The initial inventory value is the inventory monetary amount at the start of the actual results subject period and is the actual inventory value of an immediately previous actual results subject period.

The “actual selling and general administrative expense” is an item indicating a sum of expenses incurred directly for sales of the product at the sales base in the actual results subject period and expenses incurred for management activities of the sales business in the actual results subject period.

The “actual exchange rate” is an item indicating the exchange rate used by the consolidated management control assistance system 1 for currency conversion, for example, in a case in which the transaction currency at purchase of the sales subject product from the production base in the actual results subject period is different from the currency used in the consolidated management control assistance system 1. In the sales base PSI actual results table 121a illustrated in FIG. 3A, “-” is entered for a product for which the transaction currency and the currency used in the consolidated management control assistance system 1 are the same.

Moreover, specifically, the sales base PSI plan information includes data for each of the items of the sales base PSI plan table 121b illustrated in FIG. 3B. The sales base PSI plan table 121b includes, in association with one another, the various items of data that are the “sales base”, the “product category”, the “product”, the “standard selling price per unit”, a “planned selling price per unit”, a “planned sales quantity”, a “planned sales revenue”, a “planned purchase price per unit”, a “planned purchase quantity”, a “planned purchase cost”, a “planned inventory quantity”, a “planned inventory value”, a “planned selling and general administrative expense”, a “planned exchange rate”, and a “plan subject period”.

The “plan subject period” is an item indicating a period subject for realization of the various numeric data of the sales base PSI plan table 121b. In the sales base PSI plan table 121b illustrated in FIG. 3B, the plan subject period is set to be a one month period of from June 1st to June 30th that is the following month of the actual results subject period of the sales base PSI actual results table 121a illustrated in FIG. 3A. In this manner, in the present embodiment, the plan subject period is a one month long, and the sales business control device 100 is described as creating the sales base PSI plan table 121b in one month units and transmitting, as monthly sales base PSI plan information, the sales base PSI plan table 121b to the consolidated management control apparatus 300 together with the aforementioned sales base PSI actual results table 121a. Furthermore, the sales business control device 100 may create the sales base PSI plan table 121b, with the plan subject period being set to a period longer or shorter than one month, such as three months or one week, and transmit to the consolidated management control apparatus 300.

The items for the “sales base”, the “product category”, the “product”, and the “standard selling price per unit” in the sales base PSI plan table 121b are similar to the items having the same names in the aforementioned sales base PSI actual results table 121a.

The “planned selling price per unit” is an item indicating a selling price per single product estimated at the time the sales base sells the product in the plan subject period. The “planned sales quantity” is an item indicating a quantity of the product estimated to be sold in the plan subject period for the sales base. This planned sales quantity, for example, is determined in view of factors such as status of past purchases of the business connection, status of progress of business negotiations, or the like. The “planned sales revenue” is an item indicating a sum of the sales monetary amount of the product estimated to be sold in the plan subject period for the sales base. This planned sales revenue is calculated by multiplying together the planned selling price per unit and the planned sales quantity.

The “planned purchase price per unit” is an item indicating a purchase price to be set or to be requested for the production base when the sales base purchases the product from the production base in the plan subject period. The “planned purchase quantity” is an item indicating a total quantity of the product scheduled to be purchased by the sales base to purchase from the production base in the plan subject period. The “planned purchase cost” is an item indicating a sum of the purchase monetary amount of the product scheduled to be purchased by the sales base from the production base in the plan subject period. This planned purchase cost is calculated by multiplying together of the planned purchase price per unit and the planned purchase quantity.

The “planned inventory quantity” is an item indicating a quantity of the product scheduled to be held as inventory by the sales base on the end date of the plan subject period. The “planned inventory value” is an item indicating an appraised value of the product scheduled to be held as inventory by the sales base on the end date of the plan subject period. The planned inventory value is calculated, for example, by multiplying together the planned purchase price per unit and the planned inventory quantity.

The “planned selling and general administrative expense” is an item indicating a sum of expenses estimated to be incurred directly for sales of the product at the sales base in the plan subject period and expenses estimated to be incurred for management activities of the sales business in the plan subject period.

The “planned exchange rate” is an item indicating an exchange rate estimated to be used by the consolidated management control assistance system 1 for currency conversion, for example, in a case in which the transaction currency at purchase from the production base in the plan subject period is different from the currency used in the consolidated management control assistance system 1. In the sales base PSI plan table 121b illustrated in FIG. 3B, “-” is entered for a product for which the transaction currency and the currency used in the consolidated management control assistance system 1 are the same.

Again in reference to FIG. 2, the storage 120 includes a non-volatile semiconductor memory, a hard disc drive, or the like for which the stored content can be repeatedly rewritten. The storage 120 stores various types of data, such as calculation data, transmission data, and received data. Moreover, the storage 120 stores the sales business-related information 121 generated by the sales business-related information generator 111.

The communicator 130 includes a network internet card (NIC) controller, an antenna, or the like, for connection with the network NW for data communication with an external device. The communicator 130 transmits the sales business-related information 121 to the consolidated management control apparatus 300 in accordance with control by the sales business-related information transmission controller 112, for example.

The inputter 140 includes a keyboard, a mouse, a touch panel, operational buttons, or the like, and receives an operation of the user, input of data such as the sales business-related information 121, or the like.

The outputter 150 includes a display device such as a liquid crystal display (LCD), a plasma display panel (PDP), or an organic electro-luminescent (EL) display, a printer, a speaker, or the like, and outputs, for example, the content of the sales business-related information 121.

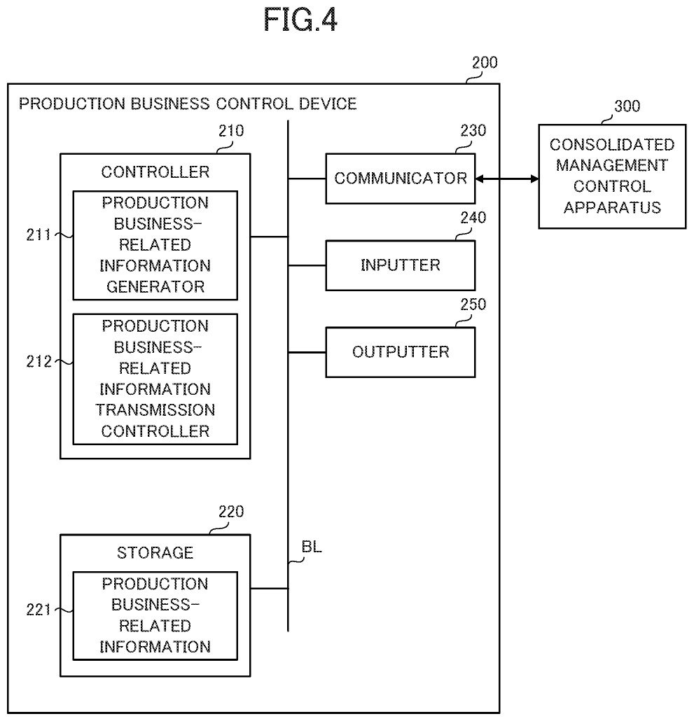

As illustrated in FIG. 4, the production business control device 200 is equipped with a controller 210, a storage 220, a communicator 230, an inputter 240, and an outputter 250. These components are interconnected electrically via the bus line BL.

The controller 210 includes a computer that includes a CPU, RAM, ROM, or the like. The controller 210 controls each of the components of the production business control device 200 by reading various types of operating programs stored in the ROM and executing the programs on the RAM.

The controller 210 functionally has a production business-related information generator 211 and a production business-related information transmission controller 212.

The production business-related information generator 211 periodically generates the production business-related information 221 that includes various types of data relating to the production business occurring at the production base. Moreover, the production business-related information generator 211 stores the generated production business-related information 221 in the storage 220 described later.

The production business-related information transmission controller 212 controls the communicator 230 to transmit the production business-related information 221 stored in the storage 220 to the consolidated management control apparatus 300.

Furthermore, the production business-related information generator 211 and the production business-related information transmission controller 212 may be included in a single computer, or each may be included in a separate computer.

Here, specific content of the production business-related information 221 is described. The production business-related information 221 includes (i) production base PSI actual results information indicating production, sales, and inventory (PSI) actual results of the production base and (ii) production base PSI plan information indicating a PSI plan of the production base.

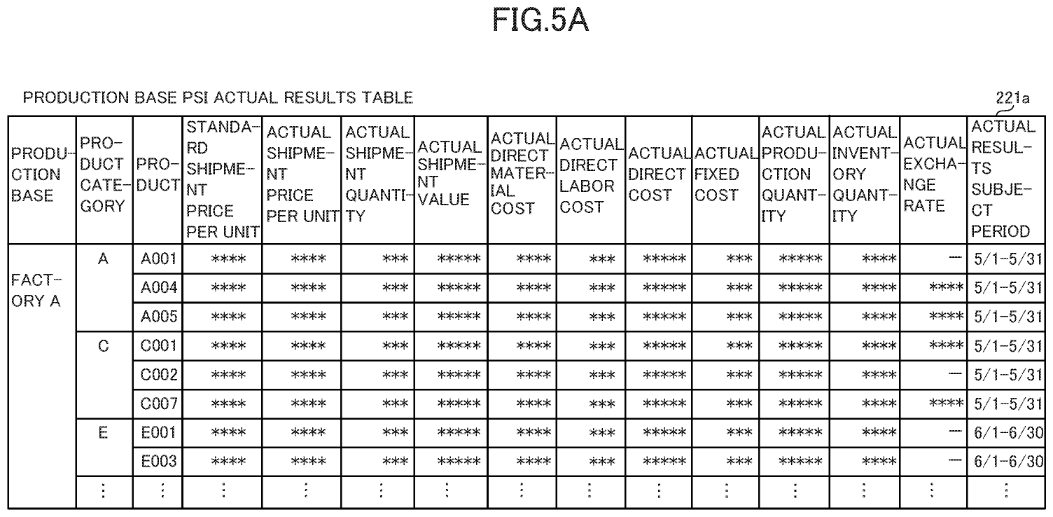

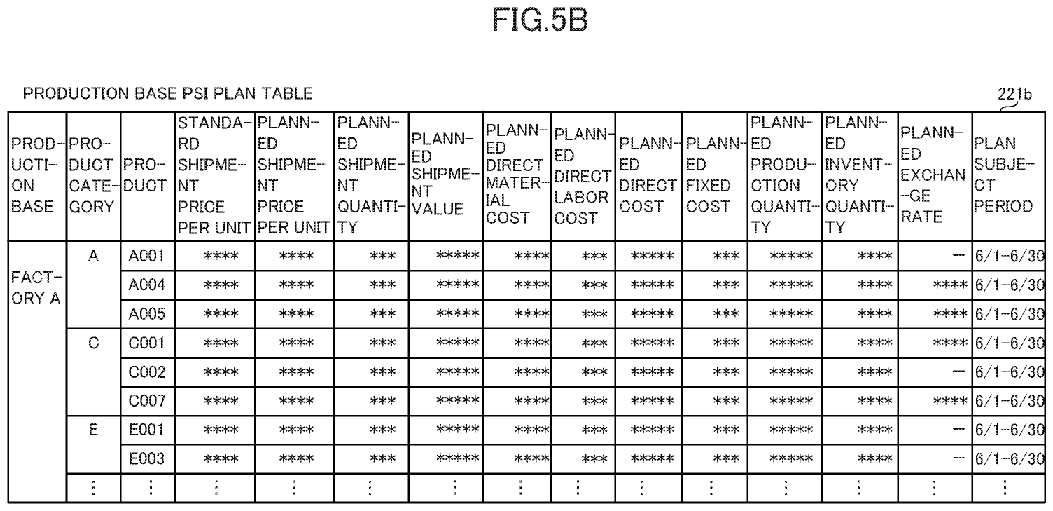

Specifically, the production base PSI actual results information includes various items of data of a production base PSI actual results table 221a illustrated in FIG. 5A. The production base PSI actual results table 221a includes, in association with one another, the various items of data that are a “production base”, the “product category”, the “product”, a “standard shipment price per unit”, an “actual shipment price per unit”, an “actual shipment quantity”, an “actual shipment value”, an “actual direct material cost”, an “actual direct labor cost”, an “actual direct cost”, an “actual fixed cost”, an “actual production quantity”, an “actual inventory quantity”, an “actual exchange rate”, and an “actual results subject period”.

The “actual results subject period” is an item indicating a period subject to calculation of the various numeric data of the production base PSI actual results table 221a. In the production base PSI actual results table 221a illustrated in FIG. 5A, the actual results subject period is set to be a one month period of from May 1st to May 31st. In this manner, in the present embodiment, the actual results subject period is a one month period, and the production business control device 200 is described as creating the production base PSI actual results table 221a in one month units and transmitting, as monthly sales base PSI actual results information, the production base PSI actual results table 221a to the consolidated management control apparatus 300 together with a production base PSI plan table 221b described later. Furthermore, the production business control device 200 may create the production base PSI actual results table 221a, with the actual results subject period being set to a period longer or shorter than one month, such as three months, one week, or the like, and transmit the production base PSI actual results table 221a to the consolidated management control apparatus 300.

The “production base” is an item indicating identification information for identifying the production base within the business group. For example, a production base ID previously assigned to each production base, or a formal name, a popular name, or the like of each production base is used for this identification information. The “product category” and the “product” items are similar to the items having the same names in the production base PSI actual results table 221a and the production base PSI plan table 221b described above. The production base PSI actual results table 221a illustrated in FIG. 5A stores items of data for each of the products, such as products “A001”, “A004”, and “A005” of a product category “A” shipped by a production base “factory A” to the sales base in the actual results subject period, products “C001”, “C002”, and “C007” of the product category “C”, or the like.

The “standard shipment price per unit” is an item indicating a shipment price per single product serving as a standard reference when the production base ships the product to each sales base. The “actual shipment price per unit” is an item indicating a shipment price per single product actually shipped by the production base to each sales base in the actual results subject period. The “actual shipment quantity” is an item indicating a total quantity of the product shipped by the production base to each sales base in the actual results subject period. The “actual shipment value” is an item indicating a sum of the monetary amounts of the products shipped by the production base to each of the sales bases in the actual results subject period. This actual shipment value is calculated by multiplying together the actual shipment price per unit and the actual shipment quantity.

The “actual direct material cost” is an item indicating a material cost actually expended for production of the product by the production base in the actual results subject period. This actual direct material cost includes (i) a main material cost that is a cost of components used as a main part of the product and (ii) a purchased component cost that is a cost of parts purchased from the outside and attached as part of the product. The “actual direct labor cost” is an item indicating wages actually incurred in the manufacture of the product by the production base in the actual results subject period. The actual direct labor cost, for example, is salary paid to factory workers directly engaged in the processing work of product production at the production base. The “actual direct cost” is an item indicating costs, other than the actual direct material cost and the actual direct labor cost, required for the manufacture of the product by the production base in the actual results subject period. This actual direct cost includes, for example, subcontracted work cost paid to a subcontractor supplied with material and commissioned to perform part of the processing work to process the product.

The “actual fixed cost” is an item indicating a fixed cost incurred regardless of the capacity utilization at the sales base in the actual results subject period. The fixed cost, for example, includes depreciation expense, facility cost, or the like.

The “actual production quantity” is an item indicating a total quantity of the product produced at the production base in the actual results subject period. The “actual inventory quantity” is an item indicating a quantity of the product held as inventory by the production base on the end date of the actual results subject period.

The “actual exchange rate” is an item indicating an exchange rate used by the consolidated management control assistance system 1 for currency conversion, for example, in a case in which the transaction currency at shipment of the product to the sales base in the actual results subject period is different from the currency used in the consolidated management control assistance system 1. In the production base PSI actual results table 221a illustrated in FIG. 5A, “-” is entered for a product for which the transaction currency and the currency used in the consolidated management control assistance system 1 are the same.

Moreover, specifically, the production base PSI plan information includes data for each of the items of the production base PSI plan table 221b illustrated in FIG. 5B. The production base PSI plan table 221b includes, in association with one another, the various items of data that are the “production base”, the “product category”, the “product”, the “standard shipment price per unit”, a “planned shipment price per unit”, a “planned shipment quantity”, a “planned shipment value”, a “planned direct material cost”, a “planned direct labor cost”, a “planned direct cost”, a “planned fixed cost”, a “planned production quantity”, a “planned inventory quantity”, a “planned exchange rate”, and a “plan subject period”.

The “plan subject period” is an item indicating a period subject for realization of the various numeric data of the production base PSI plan table 221b. In the production base PSI plan table 221b illustrated in FIG. 5B, the plan subject period is set to be a one month period of from June 1st to June 30th that is the following month of the actual results subject period of the production base PSI actual results table 221a illustrated in FIG. 5A. In this manner, in the present embodiment, the plan subject period is a one month long, and the production business control device 200 is described as creating the production base PSI plan table 221b in one month units and transmitting, as monthly production base PSI plan information, the production base PSI plan table 221b to the consolidated management control apparatus 300 together with the aforementioned production base PSI actual results table 221a. Furthermore, the production business control device 200 may create the production base PSI plan table 221b, with the actual results subject period being set to a period longer or shorter than one month, such as three months or one week, and transmit the production base PSI plan table 221b to the consolidated management control apparatus 300.

The items for the “production base”, the “product category”, the “product”, and the “standard shipment price per unit” in the production base PSI plan table 221b are similar to the items having the same name in the aforementioned production base PSI actual results table 221a.

The “planned shipment price per unit” is an item indicating the shipment price per single product estimated at the time of shipment by the production base to each sales base in the plan subject period. The “planned shipment quantity” is an item indicating a quantity of the product estimated to be shipped by the production base to each sales base in the plan subject period. This planned shipment quantity, for example, is determined in view of factors such as a purchasing schedule sent beforehand from the sales base. The “planned shipment value” is an item indicating a sum of the shipment monetary amount of the product estimated to be shipped in the plan subject period for the production base. This planned shipment value is calculated by multiplying together the planned shipment price per unit and the planned shipment quantity.

The “planned direct material cost” is an item indicating a material cost estimated to be expended for production of the product by the production base in the plan subject period. The “planned direct labor cost” is an item indicating wages estimated to be incurred in the manufacture of the product by the production base in the plan subject period. The “planned direct cost” is an item indicating costs, other than the planned direct material cost and the planned direct labor cost, required for the manufacture of the product by the production base in the plan subject period. The “planned fixed cost” is an item indicating a fixed cost estimated to be incurred regardless of the capacity utilization at the production base in the plan subject.

The “planned production quantity” is an item indicating a total quantity of the product estimated to be produced by the production base in the plan subject period. The “planned inventory quantity” is an item indicating a quantity of the product scheduled to be held as inventory by the production base on the end date of the plan subject period.

The “planned exchange rate” is an item indicating an exchange rate used by the consolidated management control assistance system 1 for currency conversion, for example, in a case in which the transaction currency at shipment of the product to the sales base in the plan subject period is different from the currency used in the consolidated management control assistance system 1. In the production base PSI plan table 221b illustrated in FIG. 5B, “-” is entered for a product for which the transaction currency and the currency used in the consolidated management control assistance system 1 are the same.

Again with reference to FIG. 4, the storage 220 includes a non-volatile semiconductor memory, a hard disc drive, or the like for which the stored content can be repeatedly rewritten. The storage 220 stores various types of data, such as calculation data, transmission data, and received data. Moreover, the storage 220 stores the production business-related information 221 generated by the production business-related information generator 211.

The communicator 230 includes an MC, an antenna, or the like, for connection with the network NW for data communication with an external device. The communicator 230 transmits the production business-related information 221 to the consolidated management control apparatus 300 in accordance with control by the production business-related information transmission controller 212, for example.

The inputter 240 includes a keyboard, a mouse, a touch panel, operational buttons, or the like, and receives an operation of the user, input of data such as the production business-related information 221, or the like.

The outputter 250 includes a display device such as an LCD, a PDP, or an organic EL display, a printer, a speaker, or the like, and outputs for example, the content of the production business-related information 221.

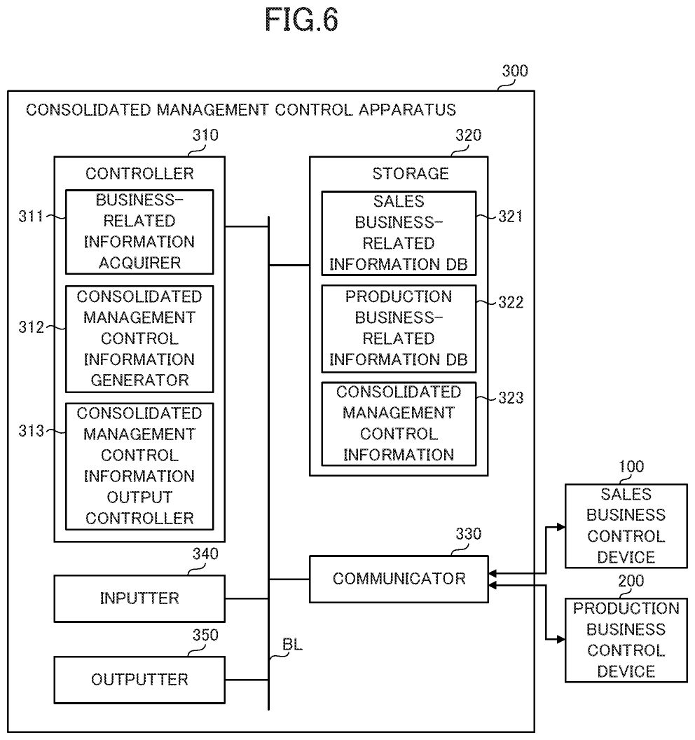

As illustrated in FIG. 6, the consolidated management control apparatus 300 is equipped with a controller 310, a storage 320, a communicator 330, an inputter 340, and an outputter 350. These components are interconnected electrically via the bus line BL.

The controller 310 includes a computer that includes a CPU, a RAM, a ROM, or the like. The controller 310 controls each of the components of the consolidated management control apparatus 300 by reading various types of operating programs stored in the ROM and executing the programs on the RAM.

The controller 310 functionally has a business-related information acquirer 311, a consolidated management control information generator 312, and a consolidated management control information output controller 313.

The business-related information acquirer 311 acquires the sales business-related information 121 and the production business-related information 221. Specifically, the business-related information acquirer 311 acquires via the below described communicator 330 (i) the sales business-related information 121 transmitted periodically from the sales business control device 100 and (ii) the production business-related information 221 transmitted periodically from the production business control device 200. Moreover, the business-related information acquirer 311 stores content of the acquired sales business-related information 121 and content of the acquired production business-related information 221 in a sales business-related information database (DB) 321 and a production business-related information DB 322 included in the below-described storage 320, respectively. Furthermore, the business-related information acquirer 311 may acquire the sales business-related information 121 by transmitting to the sales business control device 100 a request signal commanding suitable generation and transmission of the sales business-related information. Moreover, the production business-related information 221 may be acquired in the same manner.

The consolidated management control information generator 312 generates consolidated management control information 323 by using predetermined formulae to calculate numeric values of each type of items on the basis of the sales business-related information 121 acquired from the sales business control device 100 and the production business-related information 221 acquired from the production business control device 200. Moreover, the consolidated management control information generator 312 stores the generated consolidated management control information 323 in a predetermined storage region of the storage 320.

The consolidated management control information output controller 313 controls the outputter 350 to output the content of the consolidated management control information 323 stored in the storage 320.

The storage 320 includes a non-volatile semiconductor memory, a hard disc drive, or the like for which the stored content can be repeatedly rewritten. The storage 320 stores various types of data, such as calculation data, transmission data, and received data for use in consolidated business information preparation processing, for example. Moreover, the storage 320 stores the sales business-related information DB 321, the production business-related information DB 322, and the consolidated management control information 323.

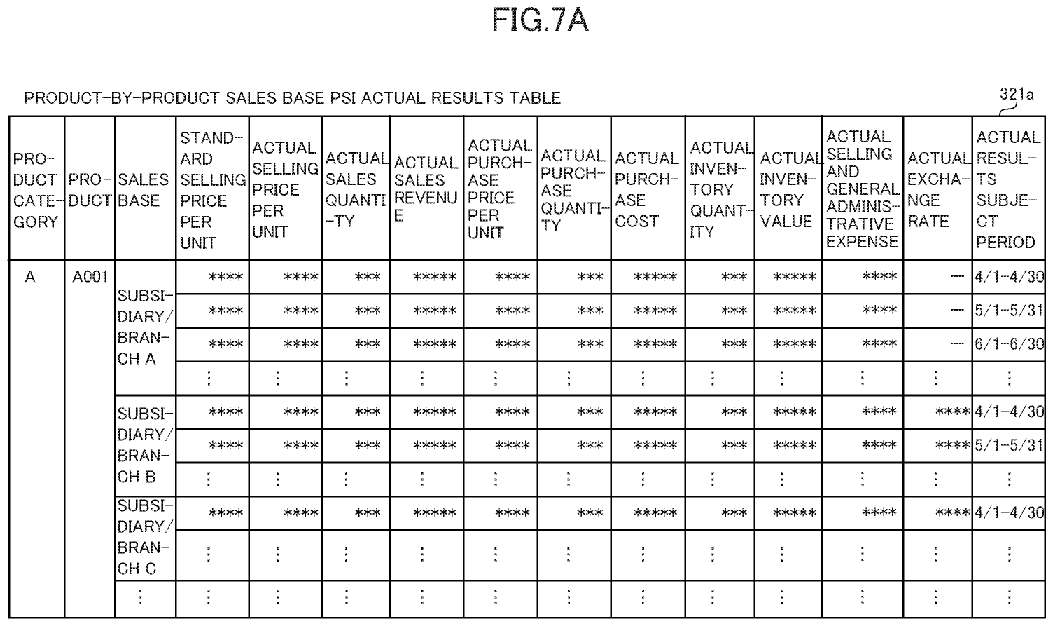

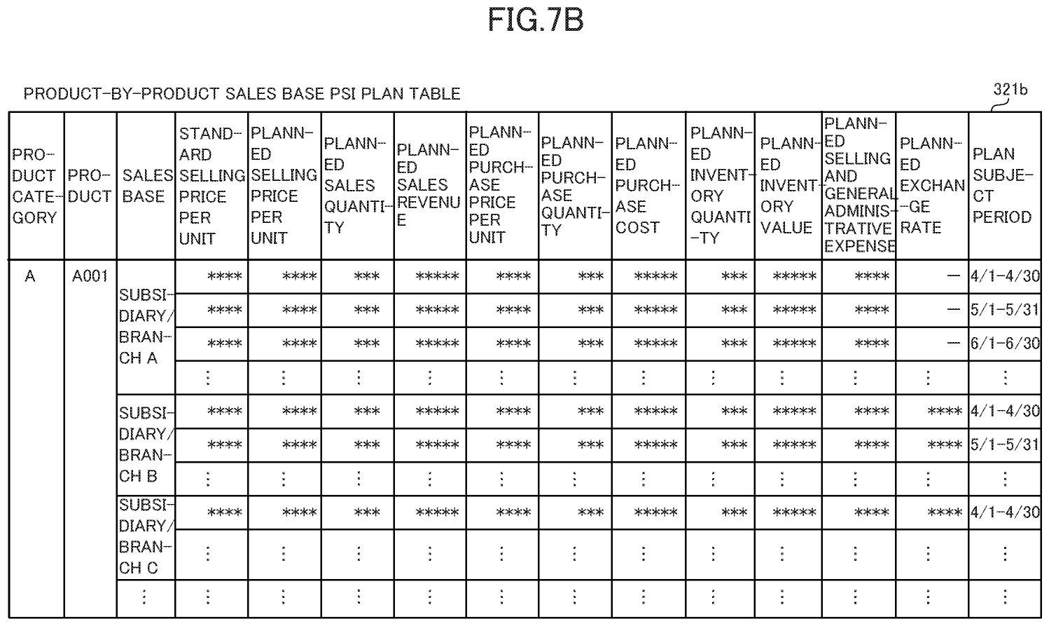

The sales business-related information DB 321 is a database in which the sales business-related information 121 acquired from the sales business control devices 100 is accumulated product-by-product. The sales business-related information DB 321 includes a product-by-product sales base PSI actual results table 321a illustrated in FIG. 7A and a product-by-product sales base PSI plan table 321b illustrated in FIG. 7B.

As illustrated in FIG. 7A, the product-by-product sales base PSI actual results table 321a is a table that includes, in association with one another, the various items of data that are the “product category”, the “product”, the “sales base”, the “standard selling price per unit”, the “actual selling price per unit”, the “actual sales quantity”, the “actual sales revenue”, the “actual purchase price per unit”, the “actual purchase quantity”, the “actual purchase cost”, the “actual inventory quantity”, the “actual inventory value”, the “actual selling and general administrative expense”, the “actual exchange rate”, and the “actual results subject period”. Each of these items is similar to the item having the same name in the aforementioned sales base PSI actual results table 121a. In the product-by-product sales base PSI actual results table 321a illustrated in FIG. 7A, the sales base PSI actual results information is accumulated in order of acquisition from the sales business control devices 100 installed at each of the sales bases selling the product “A001” belonging to the product category “A”.

Moreover, as illustrated in FIG. 7B, the product-by-product sales base PSI plan table 321b is a table that includes, in association with one another, the various items of data that are the “product category”, the “product”, the “sales base”, the “standard selling price per unit”, the “planned selling price per unit”, the “planned sales quantity”, the “planned sales revenue”, the “planned purchase price per unit”, the “planned purchase quantity”, the “planned purchase cost”, the “planned inventory quantity”, the “planned inventory value”, the “planned selling and general administrative expense”, the “planned exchange rate”, and the “plan subject period”. Each of these items is similar to the item having the same name in the aforementioned sales base PSI plan table 121b. In the product-by-product sales base PSI plan table 321b illustrated in FIG. 7B, the sales base PSI plan information is accumulated in order of acquisition from the sales business control devices 100 installed at each of the sales bases selling the product “A001” belonging to the product category “A”.

In this manner, the sales business-related information DB 321 is used for centralized management of the sales business-related information 121 acquired from the sales business control devices 100 installed at each of the sales bases, in accordance with the product-by-product sales base PSI actual results tables 321a accumulating product-by-product the sales base PSI actual results information and the product-by-product sales base PSI plan tables 321b accumulating product-by-product the sales base plan information.

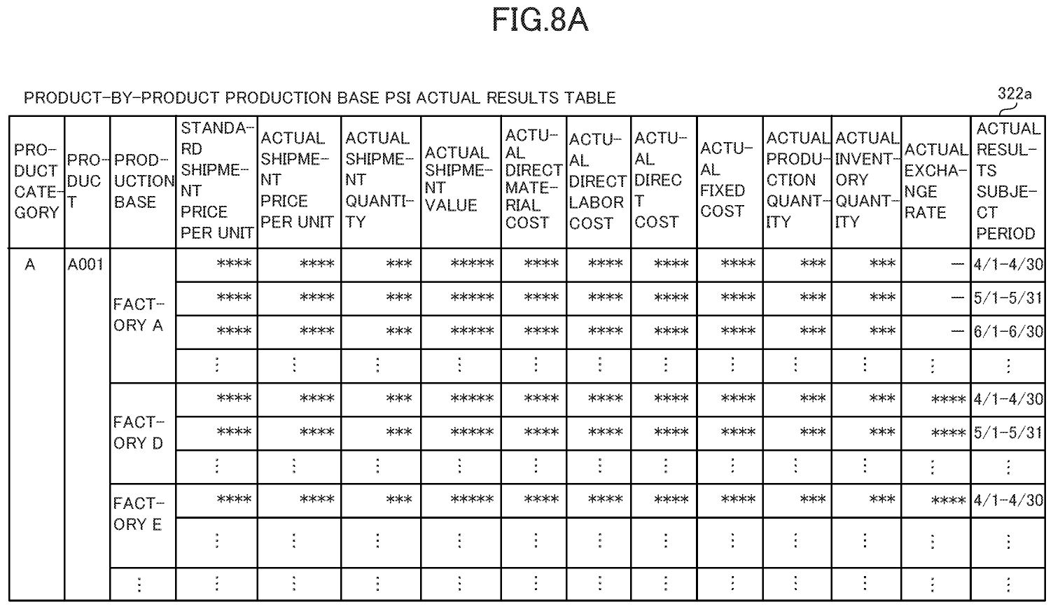

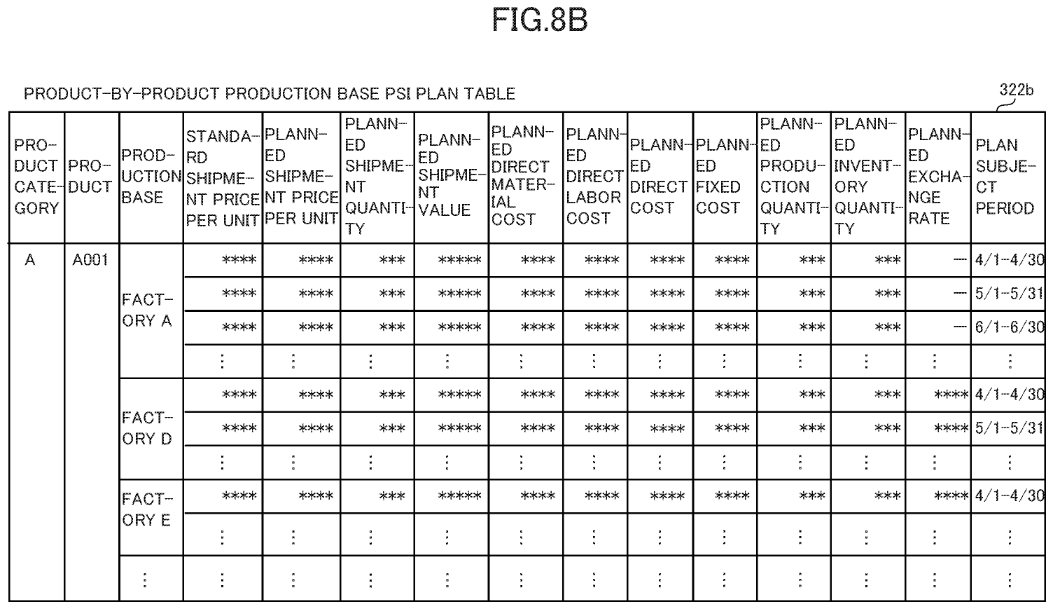

The production business-related information DB 322 is a database that accumulates product-by-product the production business-related information 221 acquired from the production business control devices 200. The production business-related information DB 322 includes a product-by-product production base PSI actual results table 322a illustrated in FIG. 8A and a product-by-product production base PSI plan table 322b illustrated in FIG. 8B.

The product-by-product production base PSI actual results table 322a, as illustrated in FIG. 8A, is a table that includes, in association with one another, the various items of data that are the “product category”, the “product”, the “production base”, the “standard shipment price per unit”, the “actual shipment price per unit”, the “actual shipment quantity”, an “actual shipment value”, the “actual direct material cost”, the “actual direct labor cost”, the “actual direct cost”, the “actual fixed cost”, the “actual production quantity”, the “actual inventory quantity”, the “actual exchange rate”, and the “actual results subject period”. Each of these items is similar to the item having the same name in the aforementioned production base PSI actual results table 221a. In the product-by-product production base PSI actual results table 322a illustrated in FIG. 8A, the production base PSI actual results information is accumulated in order of acquisition from the production business control devices 200 installed at each of the production bases producing the product “A001” belonging to the product category “A”.

Moreover, as illustrated in FIG. 8B, the product-by-product production base PSI plan table 322b is a table that includes, in association with one another, the various items of data that are the “product category”, the “product”, the “production base”, the “standard shipment price per unit”, the “planned shipment price per unit”, the “planned shipment quantity”, the “planned shipment value”, the “planned direct material cost”, the “planned direct labor cost”, the “planned direct cost”, the “planned fixed cost”, the “planned production quantity”, the “planned inventory quantity”, the “planned exchange rate”, and the “plan subject period”. Each of these items is similar to the item having the same name in the aforementioned production base PSI plan table 221b. In the product-by-product production base PSI plan table 322b illustrated in FIG. 8B, the production base PSI plan information is accumulated in order of acquisition from the production business control devices 200 installed at each of the production bases producing the product “A001” belonging to the product category “A”.

In this manner, the production business-related information DB 322 is used for centralized management of the production business-related information 221 acquired from the production business control devices 200 installed at each of the production bases, in accordance with the product-by-product production base PSI actual results tables 322a accumulating product-by-product the production base PSI actual results information and the product-by-product production base PSI plan tables 322b accumulating product-by-product the production base PSI plan information.

The consolidated management control information 323 is information that is created on the basis of various types of data contained in the sales business-related information DB 321 and the production business-related information DB 322 and includes indicator data indicating the consolidated financial status of the sales bases and the production bases occurring in the calculation subject period. The calculation subject period is a period stipulated by designation of the user and considered for calculation of various indicator data of the consolidated management control information 323. The user can designate, as the calculation subject period, a freely-selected period on a monthly basis, including a past period that is a period prior to the present month and a future period that is a period following the present month.

During the generation of the consolidated management control information 323, each of the indicator data of the consolidated management control information 323 in the past period of the calculation subject period is calculated on the basis of each of the item data of the product-by-product sales base PSI actual results table 321a of the sales business-related information DB 321 and the product-by-product production base PSI actual results table 322a of the production business-related information DB 322. Hereinafter, the numeric values of each of the indicator data of the consolidated management control information 323 occurring in the past period are termed the actual results values.

Moreover, during the generation of the consolidated management control information 323, the various indicator data of the consolidated management control information 323 occurring in the future period of the calculation subject period are calculated on the basis of each item data of the product-by-product sales base PSI plan table 321b of the sales business-related information DB 321 and the product-by-product production base PSI plan table 322b of the production business-related information DB 322. Hereinafter, the numeric values of each of the indicator data of the consolidated management control information 323 occurring in the future period are termed the predicted values.

Furthermore, the consolidated management control information 323 is generated using a generating method designated by the user from among a plurality of generating methods. In the present embodiment, two generating methods are described as a first generating method and a second generating method.

The first generating method is a method for generating the consolidated management control information 323 on the basis of the sales quantities of the sales bases.

More specifically, in the first generating method, the sales base business information, the production base business information, the related-business information, and the consolidated business information included in the consolidated management control information 323 are generated. At this time, the sales base business information is generated using the sales quantities of the sales bases, and the production base business information is generated by replacing the shipment quantities of the production bases with the sales quantities of the sales bases, taking the sales quantity of the sales base as the shipment quantity of the production base,. An objective of the first generating method is for the user to compare gross profit with profit and loss of each of the sales bases and production bases as having a purchasing-trading relationship, and to evaluate a gross profit balance, a profit-loss balance, an unrealized gross profit, and an unrealized profit and loss of either base. Detailed contents of the sales base business information, the production base business information, the related-business information, and the consolidated business information included in the consolidated management control information 323 are described later.

The second generating method is a method for generating the sales base business information on the basis of the sales quantities of the sales bases, and generating the production base business information on the basis of the shipment quantities of the production bases, thereby generating the consolidated management control information 323. More specifically, in the second generating method, the sales base business information and the production base business information included in the consolidated management control information 323 are each generated. At this time, the sales base business information is generated using the sales quantity of the sales base, and the production base business information is generated using the shipment quantity of the production base. An objective of the second generating method is for the user to know the gross profit and the profit and loss of each of the sales base and the production base that are specified as having the purchasing-trading relationship, and to evaluate product-by-product the sales capability of the sales base and the production capacity of the production base.

In the case of use of the first generating method, the consolidated management control information 323 includes the sales base business information, the production base business information, the related-business information, and the consolidated business information in the aforementioned manner.

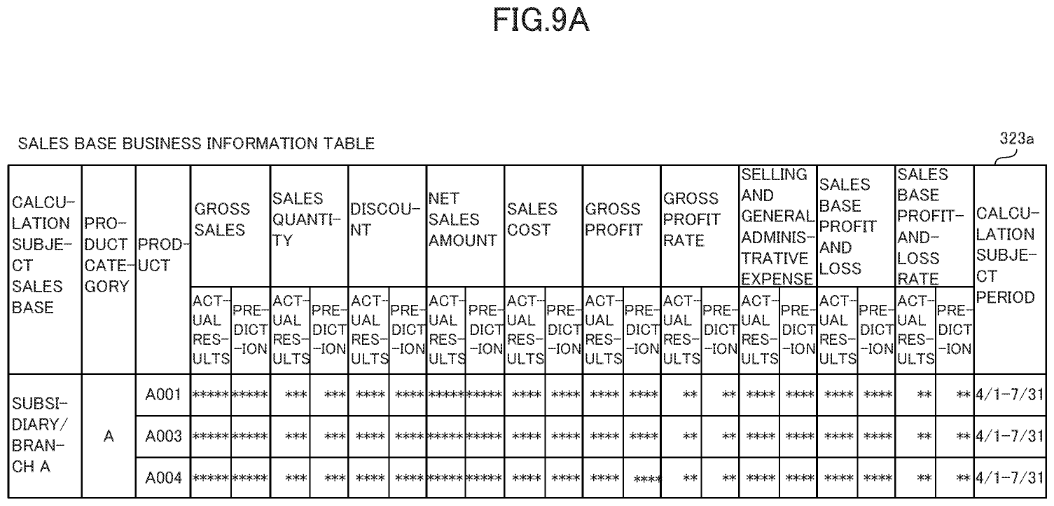

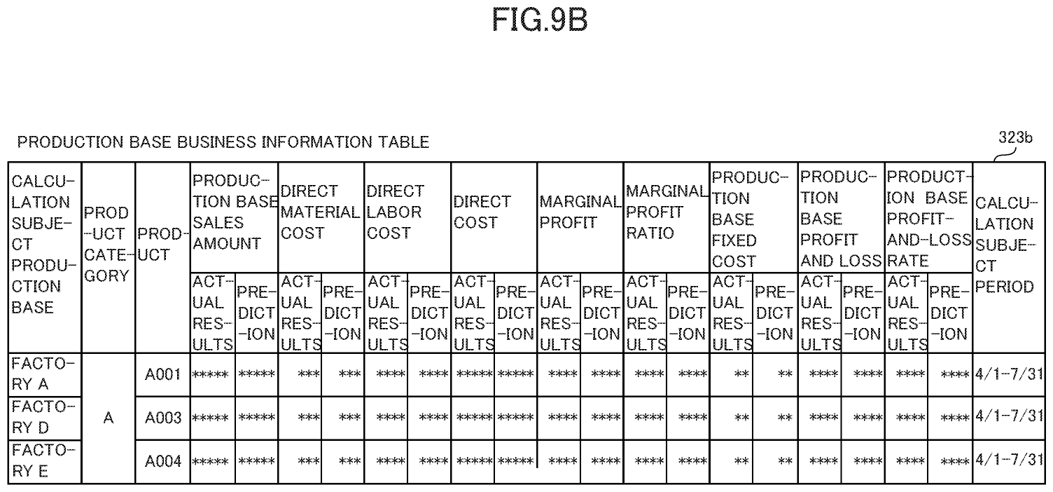

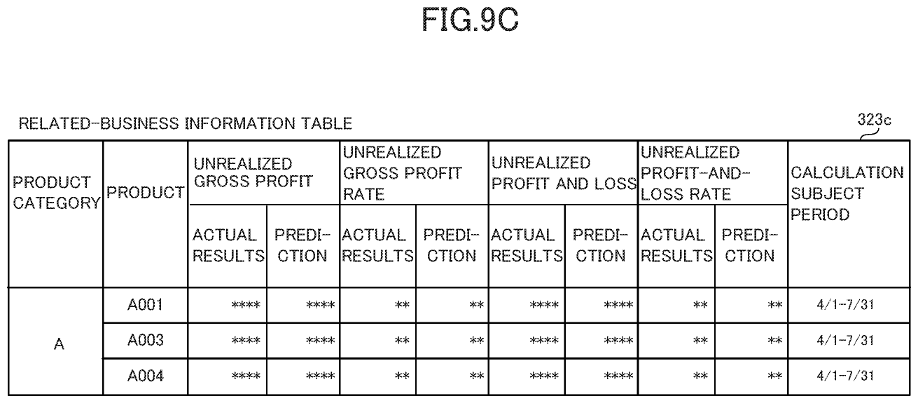

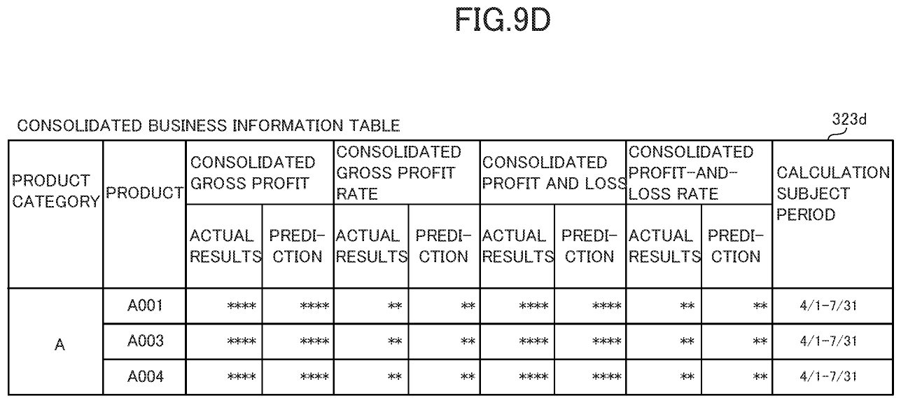

Specifically, the sales base business information includes the data of each item of a sales base business information table 323a illustrated in FIG. 9A. The sales base business information table 323a is a table for product-by-product evaluation of financial status of each sales base. As illustrated in FIG. 9A, the sales base business information table 323a is a table that includes, in association with one another, various items of data that are a “calculation subject sales base”, the “product category”, the “product”, an “gross sales”, the “sales quantity”, a “discount”, a “net sales amount”, a “sales cost”, the “gross profit”, a “gross profit rate”, the “selling and general administrative expense”, the “sales base profit and loss”, a “sales base profit-and-loss rate”, and the “calculation subject period”. Moreover, each item of the “gross sales”, the “sales quantity”, the “discount”, the “net sales amount”, the “sales cost”, the “gross profit”, the “gross profit rate”, the “selling and general administrative expense”, the “sales base profit and loss”, and the “sales base profit-and-loss rate” is indicator data indicating the financial status of the sales bases, and has subdivisions that are an “actual results value” and a “predicted value”. Hereinafter, the items subdivided into the actual results values and the predicted values are collectively termed the numeric value items.

The “calculation subject sales base” is an item indicating the sales base that is the calculation subject of each numeric value of the numeric value items of the sales base business information table 323a. A subject sales base is determined by designation by the user. The “product category” is an item indicating the product category that is the calculation subject of the various numeric values of the numeric value items of the sales base business information table 323a. The “product” is an item indicating the product that is the calculation subject of the various numeric values of the numeric value items of the sales base business information table 323a.

The “gross sales” is an item indicating a total sum of the sales amounts occurring in the calculation subject period. The actual results value of the gross sales is calculated by determining a value of “Standard selling price per unit×Actual sales quantity” for each month included in the past period of the calculation subject period, and then totaling the determined values. The predicted value of the gross sales is calculated by determining a value of “Standard selling price per unit×Planned sales quantity” for each month included in the future period of the calculation subject period, and then totaling the determined values.

The “sales quantity” is an item indicating a sum of the sales quantities occurring in the calculation subject period. The actual results value of the sales quantity is calculated by totaling the actual sales quantities of each month included in the past period of the calculation subject period. The predicted value of the sales quantity is calculated by totaling the plan sales quantities of each month included in the future period of the calculation subject period.

The “discount” is an item indicating a total sum of discount amounts occurring in the calculation subject period. The actual results value of the discount is calculated by determining a value of “(Standard selling price per unit−Actual selling price per unit)×Actual sales quantity” for each month included in the past period of the calculation subject period, and then totaling these determined values. The predicted value of the discount is calculated by determining a value of “(Standard selling price per unit−Planned selling price per unit)×Planned sales quantity” for each month included in the future period of the calculation subject period, and then totaling these determined values.

The “net sales amount” is an item indicating the net sales amount occurring in the calculation subject period. The actual results value of the net sales amount is calculated as “Actual results value of Gross sales−Actual results value of Discount”. The predicted value of the net sales amount is calculated as “Predicted value of Gross sales−Predicted value of Discount”.

The “sales cost” is an item indicating an expense incurred in purchasing a product sold in the calculation subject period, or an item indicating an expense incurred in purchasing a product estimated to be sold in the calculation subject period. The actual results value of the sales cost is calculated by determining a value of “Actual sales quantity×Actual moving average price per unit” for each month included in the past period of the calculation subject period, and then totaling the determined values. Here, the “actual moving average price per unit” is calculated as “(Prior month actual inventory value+Present month actual purchase cost)÷(Prior month actual inventory quantity+Present month actual purchase quantity)”. The predicted value of the sales cost is calculated by determining a value of “Planned sales quantity×Planned moving average price per unit” for each month included in the future period of the calculation subject period, and then totaling the determined values. Here, the “planned average price per unit” is calculated as “(Prior month inventory value+Present month planned purchase cost)÷(Prior month planned inventory quantity+Present month planned purchase quantity)”.

The “gross profit” is an item indicating gross operating income occurring in the calculation subject period. The actual results value of the gross profit is calculated as “Actual results value of Net profit—Actual results value of Sales cost”. The predicted value of the gross profit is calculated as “Predicted value of Net profit—Predicted value of Sales cost”.

The “gross profit rate” is an item indicating the rate of gross profit occurring in the calculation subject period. An actual results value of the gross profit rate is calculated as “Actual results value of Gross profit+Actual values of Net sales×100”.

A predicted value of the gross profit rate is calculated as “Predicted value of Gross profit÷Predicted value of Net sales×100”.

The “selling and general administrative expense” is an item indicating a sum of expenses incurred directly for sale of the product in the calculation subject period and expenses incurred for management activities of the sales business in the calculation subject period. The actual results value of the selling and general administrative expense is calculated by totaling the actual selling and general administrative expense of each month included in the past period of the calculation subject period. The predicted value of the selling and general administrative expense is calculated by totaling the planned selling and general administrative expense for each month included in the future period of the calculation subject period. Furthermore, the predicted value of the selling and general administrative expense may be calculated, for example, by calculating a ratio of the actual selling and general administrative expense expended in a one-year period of the previous fiscal year to the gross sales of the previous fiscal year, and by multiplying the predicted value of the gross sales by the calculated ratio.

The “sales base profit and loss” is an item indicating the profit of the sales base occurring in the calculation subject period. The actual results value of the sales base profit and loss is calculated as “Actual results value of Gross profit−Actual results value of Selling and general administrative expense”. The predicted value of the sales base profit and loss is calculated as “Predicted value of Gross profit−Predicted value of Selling and general administrative expense”.

The “sales base profit-and-loss rate” is an item indicating a ratio of the sales base profit and loss occurring in the calculation subject period to the net sales amount. The actual results value of the sales base profit-and-loss rate is calculated as “Actual results value of Sales base profit and loss÷Actual results value of Net sales amount×100”. The predicted value of the sales base profit-and-loss rate is calculated as “Predicted value of Sales base profit and loss÷Actual results value of Net sales amount×100”.

Specifically, the production base business information includes data of each item of a production base business information table 323b illustrated in FIG. 9B. The production base business information table 323b is a table for product-by-product evaluation of the financial status of the production base. The production base business information table 323b, as illustrated in FIG. 9B, is a table that includes, in association with one another, various items of data that are a “calculation subject production base”, the “product category”, the “product”, a “production base sales amount”, the “direct material cost”, the “direct labor cost”, the “direct cost”, a “marginal profit”, a “marginal profit ratio”, a “production base fixed cost”, a “production base profit and loss”, a “production base profit-and-loss rate”, and the “calculation subject period”. Moreover, each item of the “direct material cost”, the “direct labor cost”, the “direct cost”, the “marginal profit”, the “marginal profit ratio”, the “production base fixed cost”, the “production base profit and loss”, and the “production base profit-and-loss rate” is indicator data indicating the financial status of the production base, and has subdivisions that are the “actual results value” and the “predicted value”.

The “calculation subject production base” is an item indicating the production base that is the calculation subject of numeric values of the numeric value items in the production base business information table 323b. The calculation subject production base is determined in accordance with designation of the calculation subject sales base by the user. The “product category” is an item indicating the product category that is the calculation subject of numeric values of the numeric value items in the production base business information table 323b. The “product” is an item indicating the product that is the calculation subject of numeric values of the numeric value items in the production base business information table 323b.

The “production base sales amount” is an item indicating the sales amount of the production base occurring in the calculation subject period. The actual results value of the production base sales amount is calculated by determining a value of “Actual shipment price per unit×Actual sales quantity” for each month included in the past period of the calculation subject period, and then totaling the determined values. Moreover, the actual shipment price per unit of the most recent month having sales actual results is used for the actual shipment price per unit of a month having no shipment actual results. The predicted value of the production base sales amount is calculated by determining a value of “Planned shipment price per unit×Planned sales quantity” for each month included in the future period of the calculation subject period, and then totaling the determined values.

The “direct material cost” is an item indicating the direct material cost occurring in the calculation subject period. The actual results value of the direct material cost is calculated by determining a value of “Actual direct material cost per unit x Actual sales quantity” for each month included in the past period of the calculation subject period, and then totaling the determined values. Here, the actual direct material cost per unit is calculated by dividing the actual direct material cost by the actual production quantity. The predicted value of the direct material cost is calculated by determining a value of “Planned direct material cost per unit×Planned sales quantity” for each month included in the future period of the calculation subject period, and then totaling the determined values. Here, the planned direct material cost per unit is calculated by dividing the planned direct material cost by the planned production quantity. Furthermore, in the calculation of the actual results value and the predicted value of the direct material cost, a standard direct material per unit that is preset as a target value to be reached and that is stored beforehand in a predetermined storage region of the storage 320 may be used in place of the actual direct material cost per unit and the planned direct material cost per unit.

The “direct labor cost” is an item indicating the direct labor cost occurring in the calculation subject period. The actual results value of the direct labor cost is calculated by determining a value of “Actual direct labor cost per unit×Actual sales quantity” for each month included in the past period of the calculation subject period, and then totaling the determined values. Here, the actual direct labor cost per unit is calculated by dividing the actual direct labor cost by the actual production quantity. The predicted value of the direct labor cost is calculated by determining a value of “Planned direct labor cost per unit×Planned sales quantity” for each month included in the future period of the calculation subject period, and then totaling the determined values. Here, the planned direct labor cost per unit is calculated by dividing the planned direct labor cost by the planned production quantity. Furthermore, in the calculation of the actual results value and the predicted value of the direct labor cost, in the same manner as in the calculation of the direct material cost, a standard direct labor cost unit price that is preset as a target value to be reached and that is stored beforehand in a predetermined storage region of the storage 320 may be used in place of the actual direct labor cost unit price and the planned direct labor cost per unit.

The direct cost is an item indicating the direct cost occurring in the calculation subject period. The actual results value of the direct cost is calculated by determining a value of “Actual direct cost per unit×Actual sales quantity” for each month included in the past period of the calculation subject period, and then totaling the determined values. Here, the actual direct cost per unit is calculated by dividing the actual direct cost by the actual production quantity. The predicted value of the direct cost is calculated by determining a value of “Planned direct cost per unit×Planned sales quantity” for each month included in the future period of the calculation subject period, and then totaling the determined values. Here, the planned direct cost per unit is calculated by dividing the planned direct cost by the planned production quantity. Furthermore, in the calculation of the actual results value and the predicted value of the direct cost, in the same manner as in the calculations of the direct material cost and the direct labor cost, a standard direct cost per unit that is preset as a target value to be reached and that is stored beforehand in a predetermined storage region of the storage 320 may be used in place of the actual direct cost per unit and the planned direct cost per unit.

The “marginal profit” is an item indicating an amount obtained by subtracting a variable cost from the production base sales amount occurring in the calculation subject period. The actual results value of the marginal profit is calculated as “Actual results value of Production base sales amount−(Actual results value of Direct material cost+Actual results value of Direct labor cost+Actual results value of Direct cost)”. The predicted value of the marginal profit is calculated as “Predicted value of Production base sales amount−(Predicted value of Direct material cost+Predicted value of Direct labor cost+Predicted value of Direct cost)”.

The “marginal profit ratio” is an item indicating a ratio of marginal profit occurring in the calculation subject period to the production base sales amount. The actual results value of the marginal profit ratio is calculated as “Actual results value of Marginal profit+Actual results value of Production base sales amount×100”. The predicted value of the marginal profit ratio is calculated as “Predicted value of Marginal profit+Predicted value of Production base sales amount×100”.

The “production base fixed cost” is an item indicating the fixed cost occurring at the production base in the calculation subject period. The actual results value of the production base fixed cost is calculated by totaling the actual fixed cost for each month included in the base period of the calculation subject period. The predicted value of the production base fixed cost is calculated by totaling the planned fixed cost for each month included in the future period of the calculation subject period.

The “production base profit and loss” is an item indicating profit of the production base occurring in the calculation subject period. The actual results value of the production base profit and loss is calculated as “Actual results value of Marginal profit−Actual results value of Production base fixed cost”. The predicted value of the production base profit and loss is calculated as “Predicted value of Marginal profit−Predicted value of Production base fixed cost”.

The “production base profit-and-loss rate” is an item indicating a ratio of the production base profit and loss occurring in the calculation subject period to the net sales amount. Here, the net sales amount is an item of the aforementioned sales base business information table 323a. The actual results value of the production base profit-and-loss rate is calculated as “Actual results value of Production base profit and loss÷Actual results value of Net sales amount×100”. The predicted value of the production base profit-and-loss rate is calculated as “Predicted value of Production base profit and loss÷Predicted value of Net sales amount×100”.

Specifically, the related-business information includes data of each item of a related-business information table 323c illustrated in FIG. 9C. The related-business information table 323c is a table that, separately from the sales base business information table 323a and the production base business information table 323b, gathers items relating to the financial status of the sales bases and the production bases. The related-business information table 323c, as illustrated in FIG. 9C, includes, in association with one another, various items of data that are the “product category”, the “product”, the “unrealized gross profit”, the “unrealized gross profit rate”, the “unrealized profit and loss”, the “unrealized profit-and-loss rate”, and the “calculation subject period”. Moreover, each item of the “unrealized gross profit”, the “unrealized gross profit rate”, the “unrealized profit and loss”, and the “unrealized profit-and-loss rate” is indicator data relating to the financial status of the sales bases and the production bases, and has subdivisions that are the “actual results value” and the “predicted value”.

The “product category” is an item indicating the product category that is the calculation subject of numeric values of numeric value items of the related-business information table 323c. The “product” is an item indicating the product that is the calculation subject of numeric values of numeric value items of the related-business information table 323c.

The “unrealized gross profit” is an item indicating, among the gross profit generated by internal trading within the business group in the calculation subject period, the gross profit that is not yet realized. The unrealized gross profit, for example, in the case in which sales base holds as inventory the product purchased from the production base, is the profit that the production base having shipped the product sets to the inventory. The actual results value of the unrealized gross profit is calculated by determining a value of “(Actual results value of Sales cost−Actual shipment price per unit)×Actual sales quantity” for each month included in the past period of the calculation subject period, and then totaling the determined values. The predicted value of the unrealized gross profit is calculated by determining a value of “(Predicted value of Sales cost−Planned shipment price per unit)×Planned sales quantity” for each month included in the future period of the calculation subject period, and then totaling the determined values.

The “unrealized gross profit rate” is an item indicating a ratio of the unrealized gross profit occurring in the calculation subject period to the net sales amount. The actual results value of the unrealized gross profit rate is calculated as “Actual results value of Unrealized gross profit÷Actual results value of Net sales amount×100”. The predicted value of the unrealized gross profit rate is calculated as “Predicted value of Unrealized gross profit÷Predicted value of Net sales amount×100”.

The “unrealized profit and loss” is an item indicating, among the profit and loss generated by internal trading within the business group in the calculation subject period, a profit and loss that is not yet realized. The actual results value of the unrealized profit and loss is calculated by determining a value of “(Actual results value of Sales cost−Actual shipment price per unit−Actual fixed cost per unit)×Actual sales quantity” for each month included in the past period of the calculation subject period, and then totaling the determined values. Here, the actual fixed cost per unit is calculated by dividing the actual fixed cost by the actual production quantity. The predicted value of the unrealized profit and loss is calculated by determining a value of “(Predicted value of Sales cost−Planned shipment price per unit−Planned fixed cost per unit)×Planned sales quantity” for each month included in the future period of the calculation subject period, and then totaling the determined values. Here, the planned fixed cost per unit is calculated by dividing the planned fixed cost by the planned production quantity.

The “unrealized profit-and-loss rate” is an item indicating a ratio of the unrealized profit and loss occurring in the calculation subject period to the gross sales. The actual results value of the unrealized profit-and-loss rate is calculated as “Actual results value of Unrealized profit and loss÷Actual results value of Gross sales×100”. The predicted value of the unrealized profit-and-loss rate is calculated as “Predicted value of Unrealized profit and loss÷Predicted value of Gross sales×100”.

Specifically, the consolidated business information includes data of each item of a consolidated business information table 323d illustrated in FIG. 9D. The consolidated business information table 323d is a table for overall evaluation of the consolidated financial status of the sales bases and the production bases. The consolidated business information table 323d, as illustrated in FIG. 9D, includes, in association with one another, various items of data that are the “product category”, the “product”, a “consolidated gross profit”, a “consolidated gross profit rate”, a “consolidated profit and loss”, a “consolidated profit-and-loss rate”, and the “calculation subject period”. Moreover, each item of the “consolidated gross profit”, the “consolidated profit and loss”, and the “consolidated profit-and-loss rate” is indicator data indicating the consolidated financial status of the sales bases and the production bases, and has subdivisions that are the “actual results value” or the “predicted value”.

The “consolidated gross profit” is an item indicating the overall gross profit of the sales bases and the production bases occurring in the calculation subject period. The actual results value of the consolidated gross profit is calculated as “Actual results value of Gross profit+Actual results value of Marginal profit+Actual results value of Unrealized gross profit”. The predicted value of the consolidated gross profit is calculated as “Predicted value of Gross profit+Predicted value of Marginal profit+Predicted value of Unrealized gross profit”.

The “consolidated gross profit rate” is an item indicating a ratio of the consolidated gross profit in the calculation subject period to the net sales amount. The actual results value of the consolidated gross profit rate is calculated as “Actual results value of Consolidated gross profit÷Actual results value of Gross sales×100”. The predicted value of the consolidated gross profit rate is calculated as “Predicted value of Consolidated gross profit÷Predicted value of Gross sales×100”.

The consolidated profit and loss is an item indicating the overall profit and loss of the sales bases and the production bases occurring in the calculation subject period. The actual results value of the consolidated profit and loss is calculated as “Actual results value of Sales base profit and loss+Actual results value of Production base profit and loss+Actual results value of Unrealized profit and loss”. The predicted value of the consolidated profit and loss is calculated as “Predicted value of Sales base profit and loss+Predicted value of Production base profit and loss+Predicted value of Unrealized profit and loss”.

The “consolidated profit-and-loss rate” is an item indicating a ratio of the consolidated profit and loss occurring in the calculation subject period to the gross sales. The actual results value of the consolidated profit-and-loss rate is calculated as “Actual results value of Consolidated profit and loss÷Actual results value of Gross sales×100”. The predicted value of the consolidated profit-and-loss rate is calculated as “Predicted value of Consolidated profit and loss÷Predicted value of Gross sales×100”.

However, in the case of use of the second generating method, in the above described manner, the consolidated management control information 323 includes the sales base business information and the production base business information. The sales base business information and the production base business information occurring in the second generating method are similar to the sales base business information and the production base business information occurring in the first generating method, and thus detailed description of such information is omitted. However, in the second generating method rather than the first generating method, the actual shipment quantity is used in calculation of the actual results value and the predicted values of the “production base sales amount” of the production base business information table 323b.

In this manner, the consolidated management control apparatus 300 generates, in accordance with object of the user, the consolidated management control information 323 by calculating the numeric value data of various types of subdivided items according to the first generating method or the second generating method, thereby aiding in the devising of a business strategy of a business group that is opening bases globally.

Furthermore, the consolidated management control apparatus 300, for each generation of the consolidated management control information 323, may temporarily store the consolidated management control information 323 in RAM included in the controller 310, and may manage the consolidated management control information 323 compiled into a database, as in the same manner as for the sales business-related information DB 321 and the production business-related information DB 322.

Again with reference to FIG. 6, the communicator 330 is connected to the network NW and includes an MC, an antenna, or the like for data communication with external equipment. The communicator 330 receives, for example, via the network NW, the sales business-related information 121 transmitted from the sales business control device 100 and the production business-related information 221 transmitted from the production business control device 200.

The inputter 340 includes a keyboard, a mouse, a touch panel, operational buttons, or the like, and receives an operation and data input of the user. Specifically, the inputter 340 receives, as described later, designation of the calculation subject period, the calculation subject sales base, the calculation subject production base, and the generating method of the consolidated management control information 323, the display item types, or the like, and the setting of business scenarios, or the like.

The outputter 350 includes a display device such as an LCD, a PDP, an organic EL display, or the like, a printer, a speaker, or the like, and for example, outputs content of the consolidated management control information 323.

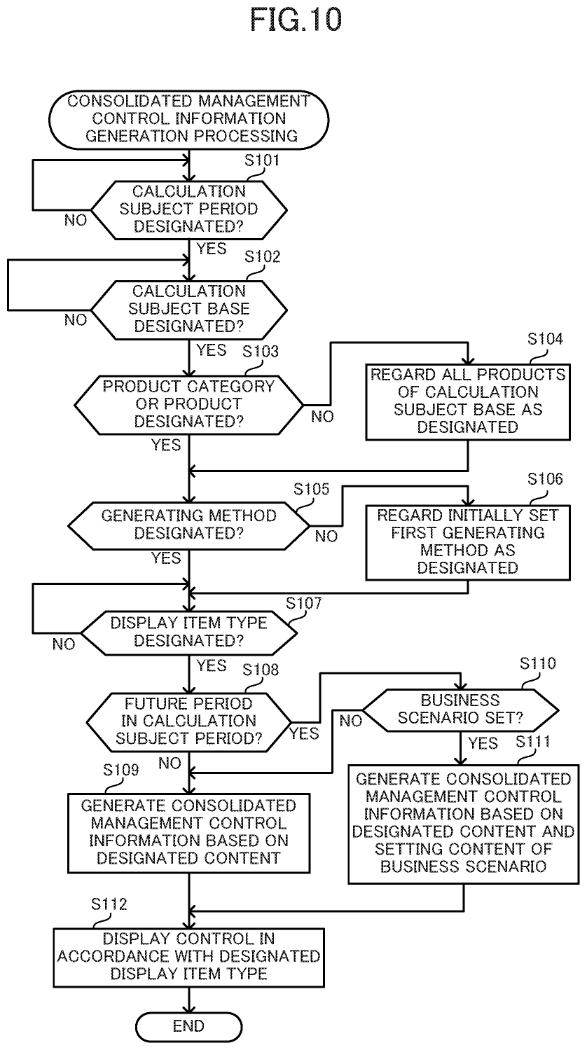

Next, consolidated management control information generation processing executed by the controller 310 of the consolidated management control apparatus 300 is described with reference to the flowchart illustrated in FIG. 10. The consolidated management control information generation processing is processing that generates the consolidated management control information 323 in accordance with the designation content and the setting content of the user, and outputs such content.

The controller 310 starts execution of the consolidated management control information generation processing in response to a startup of application software used for consolidated management control support. Upon starting of the consolidated management control information generation processing, the controller 310 determines, as a first step to generate the consolidated management control information 323, whether the calculation subject period that is the period subject to calculation is designated (step S101). The controller 310 determines absence or presence of the designation of a calculation period in accordance with whether the inputter 340 receives, from the user, designation of calculation start month and year and calculation end month and year. In the case of determination that the calculation subject period of the consolidated management control information 323 is not designated (NO in step S101), the controller 310 repeats the execution of the processing of step S101, and waits until the calculation subject period of the consolidated management control information 323 is designated.

In the case of determination that the calculation subject period of the consolidated management control information 323 is designated (YES in step S101), the controller 310 determines whether a calculation subject base that is a base of the calculation subject of the consolidated management control information 323 is designated (step S102). In the case in which at least one of the calculation subject sales bases and at least one of the calculation subject production bases are designated by the user, the controller 310 determines that the calculation subject base is designated. Furthermore, the user can designate a single or multiple sales bases as the calculation subject sales base and designate as the calculation subject production base a single or multiple production bases that are the purchasing sources of the product sold by the calculation subject sales base. In the case in which the calculations subject base is not designated (NO in step

S102), the controller 310 repeats execution of the processing of step S102, and waits until the calculation subject base is designated.

In the case of determination that the calculation subject base is designated (YES in step S102), the controller 310 determines whether the product category or the product that is the calculation subject of the consolidated management control information 323 is designated (step S103). In the case in which at least one among the products sold by the calculation subject sales base is designated, and in which a calculation subject production base is the source of purchasing of the designated product, the controller 310 determines that a product that is the calculation subject is designated. Moreover, in the case in which the product category is designated, the controller 310 regards, as being designated, all products that are sold by the sales base and are included in such a product category. In the case in which neither the product category nor the product is specified (NO in step S103), the controller 310 regards, as being designated, all products sold at the calculation subject sales base, and regards all the products as being also designated for the calculation subject production base (step S104). Furthermore, in the case in which the designation of the product category or the product by the user is not received by the inputter 340 within a predetermined period, for example, the controller 310 may determine that there is no designation of the product category or the product.

In the case of determination that the product category or the product is determined (YES in step S103), or after execution of the processing of step S104, the controller 310 determines whether the generating method is designated (step S105). In the aforementioned manner, the first generating method and the second generating method are prepared as two methods for generating the consolidated management control information 323. The user can designate a desired generating method. In the case in which the generating method is not designated (NO in step S105), the controller 310 regards the initially set first generating method as being designated (step S106).

In the case of determination that the generating method is designated (YES in step S105), or after execution of the processing of step S106, the controller 310 determines whether a display item type is designated (step S107). Here, the display item type is a type for designation for causing display of an item among the items included in each of the tables included in the consolidated management control information 323. Three of these display item types are prepared as: a “ratio display” for causing display of only ratio items indicating a ratio relative to a standard such as the gross profit rate, the sales base profit-and-loss rate, and the like; a “quantity-monetary amount display” for causing display of items indicating quantities and monetary amounts in addition to these ratio items; and a “total display” for causing display of all items. The user can designate one of the display item types and can cause just the desired items to be displayed. In the case of determination that the display item type is not designated (NO in step S107), the controller 310 repeatedly executes the processing of step S107, and waits until the display item type is designated.

In the case of determination that the display item type is designated (YES in step S107), the controller 310 determines whether a future period is included in the calculation subject period designated in step S101 (step S108).

In the case of determination that the future period is not included in the determined calculation subject period (NO in step S108), the consolidated management control information generator 312 of the controller 310, on the basis of the designated content designated in steps S101 to S106, generates the consolidated management control information 323 (step S109). Specifically, the consolidated management control information generator 312 reads the sales business-related information DB 321 and the production business-related information DB 322 stored in the storage 320, refers to the numeric values contained in each of these tables, and generates the consolidated management control information 323 in accordance with the designated content. At this time, the sales base PSI actual results information of the calculation subject sales base and the production base PSI actual results information of the calculation subject production base are used in the calculation of the actual results values corresponding to the past period of the numeric value items of each table included in the consolidated management control information 323. That is to say, the consolidated management control information generator 312 refers to the product-by-product sales base PSI actual results table 321a of the sales business-related information DB 321 and the product-by-product production base PSI actual results table 322a of the production business-related information DB 322 stored in the storage 320, and in accordance with the designated content, calculates the actual results value of the numeric value items of each table included in the consolidated management control information 323.

In the case of determination that a future period is included in the designated calculation subject period (YES in step S108), the controller 310 determines whether a business scenario is set (step S110). Here, the term “business scenario” means assumed content occurring in the future period, and such content is determined by the user's setting a designatable option setting item. Specifically, the business scenario is determined by the user setting numeric values of each item, and the business scenario includes: an assumed selling price per unit and an assumed sales quantity of the calculation subject sales base occurring in the future period, and an assumed shipment price per unit, an assumed shipment quantity, and an assumed exchange rate of the calculation subject production base occurring in the future period. By setting the business scenario, the user can acquire the consolidated management control information 323 on the basis of user-set assumed content regardless of the sales base PSI plan information of the calculation subject sales base and the production base PSI plan information of the calculation subject production base.

In the case of determination that the business scenario is set (YES in step S110), the consolidated management control information generator 312 generates the consolidated management control information 323 on the basis of the designation content designated in steps S101 to S106 and the setting content of the business scenario set in step S110 (step S111).

At this time, the setting content of the business scenario is used in the calculation of the predicted values corresponding to the future period for the numeric values items of each table included in the consolidated management control information 323. That is to say, the consolidated management control information generator 312 uses the selling price per unit and the sales quantity of the calculation subject sales base set by the business scenario in place of the “planned selling price per unit” and the “planned sales quantity” of the calculation subject sales base of the product-by-product sales base PSI plan table 321b of the sales business-related information DB 321 stored in the storage 320, uses the shipment price per unit and the shipment quantity of the calculation subject production base set by the business scenario in place of the “planned selling price per unit” and the “planned sales quantity” of the product-by-product production base PSI plan table 322b of the production business-related information DB 322 stored in the storage 320, and calculates the predicted values of the numeric value items of each table included in the consolidated management control information 323.

In the case in which the business scenario is not set (NO in step S110), the consolidated management control information generator 312 executes the processing of step S109. At this time, the sales base PSI plan information of the calculation subject sales base and the production base PSI plan information of the calculation subject production base are used in the calculation of the predicted values corresponding to the future period of the numeric value items of each table included in the consolidated management control information 323. That is to say, the consolidated management control information generator 312 refers to the product-by-product sales base PSI plan table 321b of the sales business-related information DB 321 and the product-by-product production base PSI plan table 322b of the production business-related information DB 322 stored in the storage 320, and calculates the predicted values of the numeric value item of each tables included in the consolidated management control information 323 in accordance with the designated content.

After execution of the processing of step S109 or step S111, the controller 310 stores the generated consolidated management control information 323 in the storage 320, and also the consolidated management control information output controller 313 of the controller 310, in accordance with the display item type designated in step S107, controls the outputter 350 to display, on a display screen, content of items to be displayed from among items included in each of the tables included in the consolidated management control information 323 (step S112). At this time, the controller 310 may control the outputter 350 to print the content of the consolidated management control information 323 in a predetermined format. After execution of the processing of step S112, the controller 310 ends the consolidated management control information generation processing.

Furthermore, the controller 310, as internal processing of the consolidated management control information generation processing, may receive a change of the display item type designated in step S107 by the user, and may perform control to switch between the displayed items of the consolidated management control information 323 in accordance with the changed display item type.

As described above, according to the present embodiment, the consolidated management control apparatus 300 generates the consolidated management control information 323 indicating the consolidated financial status of the sales bases and production bases designated by the user, on the basis of the sales business-related information 121 acquired from the sales business control devices 100 installed at each sales base and the production business-related information 221 acquired from the production business control devices 200 installed at each production base, and provides the consolidated management control information 323 to the user. Thus the user can know the consolidated financial status of the sales bases and the production bases that are specified as having a purchasing-trading relationship. Thus by the consolidated management control assistance system 1 according to the present embodiment, the consolidated management control apparatus 300 can effectively support determination of business policy of the business group. In particular, the consolidated management control apparatus 300 is capable of more effective support of the determination of the business policy of a business group that has diverse internal trading relationships due to having multiple production bases and sales bases.

Moreover, according to the present embodiment, the consolidated management control apparatus 300 can, in response to designation by the user, use one of the two generating methods that are the first generating method and the second generating method to generate and provide the consolidated management control information 323. Moreover, the consolidated management control apparatus 300, in response to designation of the display item type by the user, provides different content of the items to be displayed from among the items included in each table included in the consolidated management control information 323. Thus the user can check the consolidated financial status from a different viewpoint.

Moreover, according to the present embodiment, in the generation of the consolidated management control information 323, the consolidated management control apparatus 300 calculates the actual results values and the predicted values of the indicator data indicating the consolidated financial status in accordance with user designation of the calculation subject period. Moreover, the consolidated management control apparatus 300 calculates the predicted values of the indicator data for a business plan of the bases in response to the user's setting a one-of-a-kind business scenario that differs from the business plans of the bases. Thus the user can know the consolidated financial status of a freely-selected period occurring in the past through the future, and can simulate the future consolidated financial status from the one-of-a-kind viewpoint, thereby reflecting the results on the formulation of future business policy.

Moreover, according to the present embodiment, the consolidated management control apparatus 300, in response to user designation, generates and provides the consolidated management control information 323 using one of the two generating methods that are the first generating method and the second generating method. Moreover, the consolidated management control apparatus 300, in response to the user designation of the display item type, provides different contents of items to be displayed from among the items included in the tables included in the consolidated management control information 323. Thus the user can check the consolidated financial status from a different viewpoint.

Moreover, according to the present embodiment, the consolidated management control apparatus 300 takes into account trading using the local currency of sales bases and production bases located overseas, acquires actual results information and plan information of the exchange rate, and generates the consolidated management control information 323 in light of such information. Thus the user can determine product-by-product whether the change in the gross sales and/or the sales quantity of the sales base business information included in the consolidated management control information 323 is due to change in the cost, change in the exchange rate, change in the purchase price, or the like. In this manner, the consolidated management control apparatus 300 can provide to the user the consolidated financial status of bases within the business group having bases globally while appropriately reflecting real market rates that are always changing, and can contribute to the determination of consolidated business policy quickly and with high accuracy.

Further, the present disclosure is not limited to the above-described embodiment, and various types of modifications and applications are possible within a scope that does not depart from the gist of the present disclosure.

For example, the product-by-product sales base PSI actual results table 121a indicated as an example of the sales base PSI actual results information included in the sales business-related information 121 and the product-by-product sales base PSI plan table 121b indicated as an example of the sales base PSI plan information included in the sales business-related information 121 may include other items in addition to the items described in the aforementioned embodiment or in place of the items described in the aforementioned embodiment. Moreover, the same applies to the production base PSI actual results information and the production base PSI plan information included in the production business-related information 221, as well as the sales base business information, the production base business information, the related-business information, and the consolidated business information included in the consolidated management control information 323.

For example, in the aforementioned embodiment, the consolidated management control apparatus 300 may store in the storage 320 a database that contains transit lead times that are standard periods required for transit of purchased products between each sales base and each production base, and may determine, using the database, whether the planned purchase quantity occurring in the product-by-product sales base PSI plan table 321b for each sales base can be secured in the plan subject period. In the case of determination that the planned purchase quantity cannot be delivered in the plan subject period, the consolidated management control apparatus 300 may provide notification of the determination result to the subject sales business control device 100 and production business control device 200, and may request a review of the planned purchase quantity, the planned shipment quantity, or the like. This enables the consolidated management control apparatus 300 to provide, to the user, reliable consolidated management control information 323, taking into account circumstances of the shipment and product purchasing between the sales bases and the production bases occurring within the business group, which can support the determination of suitable consolidated business policy.

In the present embodiment, although the business scenario is prepared by the user freely setting assumed values for each item such as the exchange rate of the calculation subject production base occurring in the future period, the future consolidated financial status of the business group may be simulated, for example, by setting suitable numeric values as business scenario assumed sales unit prices and assumed sales quantities, in consideration of an increase in purchasing monetary amount of the sales base with an increased value of the local currency of the production base, decreased profit of the sales base with a drop in sales price, or the like. Moreover, the assumed exchange rate may be set to a proposal-based exchange rate following standard options such as “maintaining of the latest exchange rate”, “changing at a fixed rate”, “calculating in consideration of shifting in a past exchange rate”, or the like. Due to such configuration, the future consolidated financial status can be appropriately simulated, and the user can devise an accurate sales strategy.

In the aforementioned embodiment, the operational programs executed by the CPU of the controller 310 are stored in the ROM. However, the present disclosure is not limited to such configuration, and an apparatus equivalent to the consolidated management control apparatus 300 according to the aforementioned embodiment may be made to function by execution of operational programs for execution of the above-described various types of processing on an existing general-purpose computer, a framework, a workstation, or the like.

The method of providing such a program is freely selected, and for example, the program may be contained and distributed on a computer-readable recording medium such as a flexible disc, a compact disc (CD)-ROM, a digital versatile disc (DVD)-ROM, or the like; and the program may be stored on a network such as the Internet and may then be provided by downloading of the program.

Moreover, in the case in which the aforementioned processing is divided among an operating system (OS) and an application program, or in the case in which the aforementioned processing is executed in cooperation between the OS and the application program, the application program alone may be stored in the recording medium or the storage. Further, the program may be superimposed on a carrier wave, and then may be distributed via a communication network. For example, the program may be posted to a bulletin board system (BBS) on a communication network, and the program may be distributed via the network. Further, a configuration may be used such that the aforementioned processing can be executed by starting and executing the program under control of the OS in the same manner as other application programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2017-029117, filed on Feb. 20, 2017, the entire disclosure of which is incorporated by reference herein.

### REFERENCE SIGNS LIST

1 Consolidated management control assistance system
100 Sales business control device
110 Controller
111 Sales business-related information generator
112 Sales business-related information transmission controller
120 Storage
121 Sales business-related information
121a Sales base PSI actual results table
121b Sales base PSI plan table
130 Communicator
140 Inputter
150 Outputter
200 Production business control device
210 Controller
211 Production business-related information generator
212 Production business-related information transmission controller
220 Storage
221 Production business-related information
221a Production base PSI actual results table
221b Production base PSI plan table
230 Communicator
240 Inputter
250 Outputter
300 Consolidated management control apparatus
310 Controller
311 Business-related information acquirer
312 Consolidated management control information generator
313 Consolidated management control information output controller
320 Storage
321 Sales business-related information DB
321a Product-by-product sales base PSI actual results table
321b Product-by-product sales base PSI plan table
322 Production business-related information DB
322a Product-by-product production base PSI actual results table
322b Product-by-product production base PSI plan table
323 Consolidated management control information
323a Sales base business information table
323b Production base business information table
323c Related-business information table
323d Consolidated business information table
330 Communicator
340 Inputter
350 Outputter
BL Bus line
NW Network

1. A consolidated management control apparatus comprising:
an acquirer to acquire (i) sales business-related information that includes, product-by-product, actual results information and plan information for each of sales bases within a business group, and (ii) production business-related information that includes, product-by-product, actual results information and plan information for each of production bases within the business group;
a storage to store the sales business-related information and the production business-related information acquired by the acquirer;
an inputter to receive designation of at least one of the sales bases and designation of at least one of the production bases, and receive designation of at least one of products handled by both of the designated sales base and the designated production base;
a generator to generate, based on the sales business-related information and the production business-related information stored in the storage, consolidated management control information for each product designated by the inputter, the consolidated management control information including indicator data that indicates financial status of the designated sales base calculated using a sales quantity of the designated sales base and indicator data that indicates financial status of the designated production base calculated by replacing a shipment quantity of the designated production base with the sales quantity of the designated sales base; and
an outputter to output the consolidated management control information generated by the generator.

2. The consolidated management control apparatus according to claim 1, wherein
the actual results information of the sales base includes an actual sales quantity indicating a product-by-product quantity of the product actually sold to a customer,
the plan information of the sales base includes a planned sales quantity indicating a product-by-product quantity of the product estimated to be sold to the customer,
the actual results information of the production base includes an actual shipment quantity indicating a product-by-product quantity of the product actually shipped to the sales base, and
the plan information of the production base includes a planned shipment quantity indicating a product-by-product quantity of the product estimated to be shipped to the sales base.

3. The consolidated management control apparatus according to claim 2, wherein
the inputter receives designation of one of generating methods differing in calculation methods for the indicator data included in the consolidated management control information and indicating the financial status of the designated production base, and
the generator generates the consolidated management control information by using the generating method designated by the inputter to calculate the indicator data included in the consolidated management control information and indicating the financial status of the designated production base.

4. The consolidated management control apparatus according to claim 3, wherein
the generating methods include: (i) a first generating method for calculating the indicator data indicating the financial status of the designated production base by replacing the actual shipment quantity and the planned shipment quantity of the designated production base with the actual sales quantity and the planned sales quantity of the designated sales base, respectively, and (ii) a second generating method for calculating the indicator data indicating the financial status of the designated production base using the actual shipment quantity and the planned shipment quantity of the designated production base.

5. The consolidated management control apparatus according to claim 4, wherein
the inputter receives designation of a calculation subject period that is a period subject to calculation of the consolidated management control information, and
the generator (i) calculates, for a past period that is a period prior to a present month within the calculation subject period designated by the inputter, based on the actual results information of the designated sales base and the actual results information of the designated production base, an actual results value of the indicator data included in the consolidated management control information and indicating the financial status of the sales base and an actual results value of the indicator included in the consolidated management control information and indicating the financial status of the production base, and (ii) calculates, for a future period that is a period starting from the present month within the designated calculation subject period, based on the plan information of the designated sales base and the plan information of the designated production base, a predicted value of the indicator data included in the consolidated management control information and indicating the financial status of the sales base and a predicted value of the indicator data included in the consolidated management control information and indicating the financial status of the production base.

6. The consolidated management control apparatus according to claim 4, wherein
the inputter receives designation of a calculation subject period that is a period subject to calculation of the consolidated management control information, and receives setting of a business scenario that includes at least one of (i) an assumed sale unit price and an assumed sales quantity of the sales base in a future period that is a period starting from the present month within the calculation subject period, or (ii) an assumed shipment unit price and an assumed shipment quantity of the production base in the future period, and
the generator (i) calculates, for a past period that is a period prior to the present month within the calculation subject period designated by the inputter, based on the actual results information of the sales base and the actual results information of the production base, an actual results value of the indicator data included in the consolidated management control information and indicating the financial status of the sales base and an actual results of value of the indicator data included in the consolidated management control information and indicating the financial status of the production base, and (ii) calculates, for the future period, based on a setting content of the business scenario set by the inputter, a predicted value of the indicator data included in the consolidated management control information and indicating the financial status of the sales base and a predicted value of the indicator data included in the consolidated management control information and indicating the financial status of the production base.

7. A consolidated management control assistance system for supporting determination of business policy of a business group, the system comprising:
a sales business control device;
a production business control device; and
a consolidated management control apparatus, wherein
the sales business control device is installed at each of sales bases, and generates sales business-related information including actual results information and plan information and supplies the sales business-related information to the consolidated management control apparatus,
the production business control device is installed at each of production bases, and generates production business-related information including actual results information and plan information and supplies the production business-related information to the consolidated management control apparatus, and
the consolidated management control apparatus generates, based on the sales business-related information acquired from the sales business control device and the production business-related information acquired from the production business control device, consolidated management control information including (i) indicator data calculated using the sales quantity of a sales base specified out of the sales bases and indicating the financial status of the specified sales base and (ii) indicator data calculated by replacing, with the sales quantity of the specified sales base, the shipment quantity of the production base specified as having a purchasing-trading relationship with the specified sales base, the indicator data indicating the financial status of the specified production base, and the consolidated management control apparatus outputs the consolidated management control information.

8. A consolidated management control assistance method comprising:
an acquiring step of acquiring (i) sales business-related information that includes, product-by-product, actual results information and plan information for each of sales bases within a business group, and (ii) production business-related information that includes, product-by-product, actual results information and plan information for each of production bases within the business group;
a storing step of storing the sales business-related information and the production business-related information acquired in the acquiring step;
an input receiving step of receiving designation of at least one of the sales bases and designation of at least one of the production bases, and receiving designation of at least one of products handled by both of the designated sales base and the designated production base;
a generating step of generating, based on the sales business-related information and the production business-related information stored in the storing step, consolidated management control information for each product designated in the input receiving step, the consolidated management control information including indicator data that indicates financial status of the designated sales base calculated using a sales quantity of the designated sales base and indicator data that indicates financial status of the designated production base calculated by replacing a shipment quantity of the designated production base with the sales quantity of the designated sales base; and
an outputting step of outputting the consolidated management control information generated in the generating step.

9. A non-transitory computer-readable recording medium storing a program, the program causing a computer to execute:
acquiring processing of acquiring (i) sales business-related information that includes, product-by-product, actual results information and plan information for each of sales bases within a business group, and (ii) production business-related information that includes, product-by-product, actual results information and plan information for each of production bases within the business group;
storing processing of storing the sales business-related information and the production business-related information acquired in the acquiring processing;
input receiving processing of receiving designation of at least one of the sales bases and designation of at least one of the production bases, and receiving designation of at least one of products handled by both of the designated sales base and the designated production base;
generating processing of generating, based on the sales business-related information and the production business-related information stored in the storing processing, consolidated management control information for each product designated in the input receiving processing, the consolidated management control information including indicator data that indicates financial status of the designated sales base calculated using a sales quantity of the designated sales base and indicator data that indicates financial status of the designated production base calculated by replacing a shipment quantity of the designated production base with the sales quantity of the designated sales base; and
outputting processing of outputting the consolidated management control information generated in the generating processing.
